(19) United States
(12) Patent Application Publication
(10) Pub. No.: US 2026/0121148 A1
(43) Pub. Date: Apr. 30, 2026

(54) Low-temperature life extension system for wind turbine coupled with energy storage

(71) Applicant: Leo Sun, Charlotte, NC (US)

(72) Inventors: Benhu Lyu, Luoyang (CN); Yueqin Cui, Luoyang (CN)

(21) Appl. No.: 19/433,831

(22) Filed: Dec. 28, 2025

(30) Foreign Application Priority Data
Sep. 19, 2025 (CN) 2025113480946

(51) Int. Cl. H01M 10/613; F03D 9/11; H01M 10/627; H01M 10/63

(52) U.S. Cl. CPC H01M 10/613; F03D 9/11; H01M 10/627; H01M 10/63; H01M 2220/10

(57) ABSTRACT

This invention discloses a low-temperature life extension system for wind turbine coupled with energy storage. Its functional units include a battery module, a temperature maintaining device, a wind turbine, and a collaborative control module. Through intelligent algorithms, it performs collaborative optimization of battery temperature control, charging and discharging processes, and wind turbine energy storage interaction, achieving a balance between low-temperature life extension and energy efficiency optimization. This system improves the output stability and grid friendliness of the wind turbine, reduces the system's total life-cycle energy consumption, and enhances economic efficiency and reliability. This invention is applicable to onshore and cold-region wind farms, providing an efficient and sustainable solution for wind power energy storage systems.

### CROSS REFERENCE TO RELATED APPLICATIONS

This application claims the priority benefit of Chinese Patent Application No. 2025113480946, filed on 19 Sep. 2025, the entire contents of which are hereby incorporated by reference.

### TECHNICAL FIELD

This invention relates to the field of wind power generation and energy storage system coupling technology, specifically a low-temperature life extension system for wind turbine coupled with energy storage.

### BACKGROUND OF THE INVENTION

With the rapid growth of wind power generation, its intermittency and volatility have become increasingly prominent, and energy storage systems have gradually become an important support for achieving efficient utilization of wind energy and stable operation of the power grid. The deep integration of wind power generation and energy storage systems is becoming an important direction for the development of new energy technologies.

Electrochemical energy storage, especially lithium batteries, has become the mainstream solution for wind power energy storage. However, battery performance is highly dependent on the temperature environment. In particular, in low-temperature scenarios, battery capacity, charge and discharge efficiency and power output will decrease significantly, thus limiting the application potential of wind power generation in cold regions or winter.

Existing energy storage systems typically use heating or insulation devices to avoid the impact of low-temperatures on battery performance. This approach is a passive measure, with the main goal of restoring or maintaining battery performance rather than improving lifespan or system economy, and it will additionally increase energy consumption and operation and maintenance costs.

Meanwhile, the cycle life and safety of batteries remain the focus of the industry. With the continuous increase in wind turbine capacity and single-unit power, the demand for low-temperature performance and long life of battery module is becoming more urgent. How to balance economy, safety and energy efficiency optimization in energy storage systems has become a technical problem that needs to be solved.

The above-mentioned problems provide clear room for improvement for the present invention, highlighting the innovative value and industrial application prospects of the present invention in low-temperature life extension, energy storage coupling and system energy saving.

### SUMMARY OF THE INVENTION

This invention aims to solve the core problem of wind turbine coupled energy storage systems in actual operation: how to significantly extend the life of battery module in low-temperature environments, while taking into account energy efficiency optimization, structural reuse, and wind turbine operation stability. This invention proposes a brand-new concept with “actively embracing low-temperatures and extending lifespan” as its core, and achieves a breakthrough through systematic innovation.

Traditional energy storage system thermal management only aims to maintain the battery at room temperature to avoid the adverse effects of high and low-temperatures. Its design philosophy is “avoid high temperatures, avoid low-temperatures, and maintain room temperature.” However, the inventors have discovered through long-term experiments that when various types of batteries operate in the low-temperature range (below room temperature but above the freezing point), their aging and degradation rates are significantly slowed down, and their cycle life may be extended by three to four times. This discovery overturns the traditional understanding that “low-temperatures are necessarily detrimental” and proposes a brand-new design concept of “embracing low-temperatures and embracing longevity.”

Based on this, the present invention designs a low-temperature life-extending energy storage temperature control scheme, which uses a temperature maintaining device to stably maintain the battery module in the low-temperature operating range, actively utilizes the low-temperature life-extending effect, significantly extends battery life, and improves the economy and reliability of the entire life cycle. At the same time, combined with a collaborative control module, it realizes the collaborative optimization of energy management, capacity redundancy and temperature control scheme, and avoids the contradiction between performance degradation and energy consumption increase at low-temperatures.

This invention not only breaks through the traditional technical bottleneck of relying on heating to maintain room temperature, but also achieves the integration of low-temperature life extension, energy efficiency optimization and wind turbine energy storage through scientific layout and multi-level coupling temperature control scheme, which has outstanding technical progress and application value.

The technological innovation of this invention is applicable to various wind power generation scenarios, especially onshore and cold-region wind farms. It can flexibly deploy battery modules according to the structure of wind turbines, maintenance strategies and wind farm environmental conditions, and achieve a high-efficiency unity of low-temperature life extension and energy efficiency optimization, providing a brand-new wind power energy storage system solution.

In summary, the present invention extends battery life and optimizes system energy consumption by actively utilizing the low-temperature environment, and designs an energy storage system in combination with the characteristics of wind power generation, thus forming a set of efficient, sustainable and economically significantly improved low-temperature life extension technology solutions.

The low-temperature life extension system for wind turbine coupled with energy storage proposed in this invention integrates multiple innovations such as low-temperature life extension, counterweight reuse, energy storage coupling, and collaborative control, and has many advantages. Low-temperature life extension: This invention actively maintains the operating temperature of the battery module in a low-temperature range below room temperature, using the low-temperature environment to delay the aging of electrodes and electrolytes, thereby significantly extending battery life and improving system reliability and life-cycle economy. Structural reuse: The battery module can also serve as a counterweight, partially or completely replacing the original counterweight components of the wind turbine, realizing the integration of energy storage and counterweight. This design not only saves space and materials, but also optimizes the overall center of gravity and dynamic performance of the wind turbine, reducing transportation, installation, and maintenance costs. Energy storage coupling: Through the collaborative control module, the battery module and the wind turbine achieve deep energy interaction. Energy is stored when wind energy is abundant and released when wind energy is insufficient or when grid dispatch requires it, improving the smoothness of wind turbine output and grid friendliness, and realizing the integrated operation of wind turbine and energy storage. Collaborative Control and Energy Efficiency Optimization: The collaborative control module integrates battery management system functions, monitors battery status, balances individual cell voltage and capacity, and interacts with the temperature control device to achieve a balance between extending battery life at low-temperatures and optimizing energy efficiency. Through passive cooling or multi-stage coupled temperature control schemes, the system extends battery life at low-temperatures while maintaining controllable energy consumption. Flexible Deployment and Scalability: Battery module and temperature control devices may be designed as an integrated unit or distributed, achieving efficient temperature control through flexible thermal coupling, adapting to different wind turbine structures, wind farm environments, and maintenance strategies. Modular interface design facilitates expansion, replacement, and long-term operation and maintenance, enhancing the system's sustainability and economy.

Therefore, through the comprehensive innovation of “low-temperature life extension+reusable matching+energy storage coupling+coordinated control”, this invention not only achieves a significant extension of battery life and a reduction in system cost, but also enhances the coordination capability between wind turbines and the power grid, demonstrating significant technological progress and broad application prospects.

The technical solution of the present invention appears similar to the thermal management and energy dispatching modes of existing wind power energy storage systems at first glance, but in fact there are essential differences. Existing technologies generally follow the traditional concept of “avoiding low-temperatures and maintaining normal temperatures,” repairing the performance degradation of batteries at low-temperatures through heating or insulation, which is a passive remedial measure. However, the present invention, based on long-term system experiments, has found that when batteries operate in the low-temperature range, their cycle life is not only not shortened, but may be significantly extended, even reaching three to four times that under normal temperature conditions. This experimental result completely overturns the traditional understanding, fundamentally changing the goal of battery thermal management from “avoiding low-temperatures” to “actively embracing low-temperatures,” achieving a leap from passive defense to active life extension.

Based on this, the present invention further proposes an innovative design that deeply couples the battery module with the wind turbine structure. The battery module not only serves as an energy storage unit, but also acts as a counterweight, partially or completely replacing the original counterweight components of the wind turbine. This concept breaks through the traditional boundary between the independent functions of energy storage and structure, realizing the organic unity of the mechanical characteristics of the energy storage unit and the unit, significantly improving space utilization, reducing structural costs, and improving the overall dynamic performance of the wind turbine. When faced with the problem of wind turbine counterweight, those skilled in the art usually only use inert materials such as concrete or steel blocks, and would not naturally think of combining energy storage batteries with the counterweight function. Therefore, this design has outstanding non-obviousness.

This invention also integrates low-temperature life extension strategy, capacity redundancy mechanism and wind turbine energy storage coupled operation through a collaborative control module, achieving a unified approach to battery life extension, energy efficiency optimization and grid friendliness. Unlike existing methods that rely solely on independent energy storage devices to smooth wind power fluctuations, this invention emphasizes the deep integration of wind turbines and energy storage, using intelligent control strategies to make wind turbine output more stable, significantly improving grid adaptability and the overall economic efficiency of wind farms.

Therefore, this invention not only achieves a disruptive shift in battery thermal management concepts from “avoiding low-temperatures” to “utilizing low-temperatures,” but also proposes a new model for the reuse of battery modules and wind turbine structures at the system architecture level, and achieves optimal energy efficiency through coordinated control. These innovations constitute a technological breakthrough that has not been disclosed or implied in the prior art, and have significant creative value and broad industrial application value.

Specifically, the present invention discloses a low-temperature life extension system for wind turbine coupled with energy storage, characterized in that,
The low-temperature life extension system includes several functional units, sub-components and secondary components. The functional units may include, but are not limited to, battery module, temperature maintaining device, wind turbine and collaborative control module.
The battery module is used to store electrical energy generated by the wind turbine.
The temperature maintaining device can regulate the temperature of the battery module and maintain it within the low-temperature operating range to achieve the purpose of extending battery life at low-temperatures.
The wind turbine is used to convert wind energy into electrical energy and interact with the battery module.
The collaborative control module can acquire the operating status and external environment information of each functional unit in the low-temperature life extension system, and perform collaborative optimization control of each functional unit in the low-temperature life extension system in conjunction with the decision control algorithm.
The low-temperature operating range is a range of temperatures above the dew point but below room temperature. When the battery module is used for a long time within the low-temperature operating range, the aging or degradation of electrode materials and electrolytes will be effectively delayed, significantly extending the life of the battery module, thereby improve the economic efficiency of the entire life cycle.
Any functional unit or its sub-components and secondary components of the low-temperature life extension system may be selected with anti-vibration structures as needed to suppress vibrations and shocks generated during operation;
The temperature maintaining device is designed to actively promote a decrease in temperature (to extend service life), rather than being used solely to prevent thermal runaway in the traditional sense.
The functional unit refers to the overall module used to realize the main function in the low-temperature life extension system. The sub-component refers to the subdivided structure or independently operable component under the functional unit. The secondary component refers to the specific element or hardware component after further subdivision of the sub-component.

The advantages of this design are mainly reflected in three aspects. First, it improves battery life. Long-term operation in low-temperature environments can reduce capacity decay and extend the service life. Second, it improves energy utilization efficiency. By combining wind power generation and energy storage, it achieves efficient conversion and flexible application of clean energy. Third, it optimizes intelligent control. The collaborative control module enables the system to have adaptive capabilities, automatically adjusting strategies according to environmental changes to ensure stable operation and economy. This solution not only helps reduce operation and maintenance costs but also enhances the reliability and sustainability of renewable energy in practical applications.

Optionally, the functional units, sub-components and secondary components of the low-temperature life extension system may be selected and configured as needed; wherein the electrical parts adopt a sealed structure to suppress condensation and enhance the system's adaptability to low-temperature environments.

Optionally, when the battery module operates in the low-temperature operating range, although the battery module's lifespan may be extended, its initial capacity will be reduced due to the decrease in the electrochemical reaction rate; therefore, the battery module can also be configured with a capacity redundancy function.

Optionally, the capacity redundancy function compensates for the negative impact of low-temperature environment on the capacity of the battery module by reserving additional capacity in advance; the capacity redundancy function is an optional configuration.

Optionally, the collaborative control module can ensure that one or more characteristic variables of the battery module do not exceed the operating condition threshold during charging and discharging, thereby avoiding damage to the battery module due to excessively high side reaction rates under adverse conditions; the characteristic variables include charging current.

Optionally, the characteristic variables may also include one or more of the following: charging voltage, discharging voltage, discharging current, charging and discharging power, temperature, and other battery operating parameters.

Optionally, when the collaborative control module detects that one or more characteristic variables are close to or exceed the operating condition threshold, the collaborative control module will activate protection measures; the forms of protection measures include reducing charging current, reducing discharging current, limiting power or voltage, cutting off the charging and discharging circuit, and issuing an alarm signal.

Optionally, the capacity redundancy function is achieved by adding an auxiliary battery pack to the battery module and operating it in coordination, or by designing the total capacity of the battery module according to a preset redundancy ratio, so that the actual total capacity exceeds the requirements of the application scenario to achieve redundancy.

Optionally, the capacity redundancy function can selectively enable or disable the auxiliary battery pack or automatically adjust the overall operating intensity of the battery module according to the external load demand, so that the total capacity of the battery module can flexibly meet the external load demand and can respond in time when the demand suddenly increases.

Optionally, the capacity redundancy function can not only compensate for the capacity loss of the battery module in the low-temperature life extension range, but also further improve the life of the battery module on the basis of the life extension caused by low-temperature.

Optionally, the sub-components of the collaborative control module include a sensor network, which monitors on demand the characteristic variables of any functional unit or its sub-components, and secondary components of the low-temperature life extension system, along with external environmental parameters.

Optionally, the collaborative control module also integrates the functions of a battery management system, including but not limited to monitoring and managing the operating status of the battery module, balancing the voltage and capacity of each individual cell in the battery module, and interacting with any sub-component or secondary component in the temperature maintaining device to achieve collaborative and optimized energy management.

The design achieves a balance and optimization of lifespan, performance and stability through capacity redundancy, sensor network and battery management. At the same time, the anti-vibration structure ensures the long-term stability of the wind turbine, providing support for the practicality and economy of the wind energy storage system.

Optionally, when applied in offshore wind power scenarios, the battery module can also serve as a counterweight, partially or completely replacing the original counterweight components of the wind turbine, thereby achieving structural reuse and cost savings.

Optionally, any functional unit or any sub-component or secondary component of the low-temperature life extension system has high flexibility in spatial arrangement and may be optimized and deployed according to wind farm environmental conditions, temperature control requirements, maintenance convenience, wind turbine structural constraints, airflow channels, local temperature control optimization, heat load balance, vibration isolation requirements, electrical circuit layout, load bearing capacity, maintenance strategy, and ease of installation and replacement.

Optionally, the battery module may not serve as a counterweight and may not be used as a counterweight component of the wind turbine. Instead, it may be arranged as a pure battery module in the empty space inside the tower or on the tower base platform to adapt to different wind turbine structures and installation requirements.

The design highlights are functional reuse and flexible layout. The battery module not only serves as energy storage but also replaces the wind turbine counterweight, achieving multiple uses and reducing structural costs. The functional units and sub-components are arranged flexibly and may be optimized according to environmental and maintenance needs, making the system adaptable to different wind farms and turbine models, taking into account both practicality and economy.

Optionally, the size, mass, center of gravity distribution, and deployment position of the battery module may be optimized and customized according to the rated power, rotor length, tower height and structural characteristics of the wind turbine to meet the overall center of gravity and stability requirements of the wind turbine.

Optionally, the battery module may be arranged in any of the following ways: inside the wind turbine tower; inside the wind turbine nacelle; in an independent energy storage compartment adjacent to the wind turbine; or near the centralized control station or collection line node of the wind farm.

Optionally, the sub-components of the battery module include a battery, an energy storage compartment and a modular interface; the energy storage compartment is a shell structure used for the battery module and provides sealing and protection; the modular interface is used to enable the expansion, replacement or maintenance of the battery module.

Optionally, the temperature maintaining device can adopt a passive heat dissipation strategy as needed to reduce heat dissipation energy consumption.

This section emphasizes the customization and flexible deployment of battery module. Size, weight, and center of gravity may be optimized to ensure stability, and the placement is flexible and diverse. The module structure takes into account protection, capacity expansion, and maintenance. Collaborative control and capacity redundancy enhance emergency response capabilities. Temperature control adopts passive heat dissipation, reflecting a safe, flexible, and efficient systematic design.

Optionally, the temperature maintaining device may use any of the following temperature control methods: passive heat dissipation, air cooling, convection cooling, active cooling and thermal compensation. Alternatively, two or more of these methods may be combined to construct a multi-level coupling temperature control scheme to meet the needs of different environmental conditions and heat loads. At the same time, the temperature maintaining device may be configured with corresponding sub-components according to actual needs to achieve the required temperature control method.

Optionally, the energy storage compartment can achieve passive heat dissipation by being in close contact with the structure of the wind turbine and utilizing its thermal conductivity and heat dissipation characteristics.

Optionally, the sub-component of the temperature maintaining device may further include a liquid cooling circuit to achieve convective heat dissipation.

Optionally, the liquid cooling circuit can adopt any of the following methods: plate liquid cooling, tube liquid cooling, microchannel liquid cooling, immersion liquid cooling, sandwich liquid cooling or shell integrated liquid cooling, or a combination of multiple methods to achieve heat exchange of the battery module.

Optionally, the secondary components of the liquid cooling circuit may include liquid cooling plates, cooling pipes, serpentine pipes, coils, microchannel cooling plates, jacketed cooling fins, liquid cooling shells, liquid pumps, heat exchangers, heat dissipation terminals, control valves, sensors, and coolant storage tanks, and may be freely selected and flexibly combined according to different liquid cooling requirements and design schemes.

Optionally, the battery module can directly contact the temperature maintaining device or any of its sub-components or secondary components as needed to achieve efficient thermal coupling.

Optionally, the battery module may be physically integrated with the temperature maintaining device or any of its sub-components or secondary components as needed to form a unified and indivisible functional unit.

Optionally, the battery module and the temperature maintaining device or any of its sub-components or secondary components can also be arranged relatively independently and separately, and efficient thermal coupling may be achieved through flexible heat conduction pipes, liquid cooling circuits or thermal conduction interfaces, so that they may be flexibly deployed according to the wind turbine structure, environmental conditions and maintenance strategies.

Optionally, the battery module or the temperature maintaining device may be installed as needed in the tower of the wind turbine, the surrounding structure of the tower, the interior of the nacelle, the foundation platform, the ground auxiliary cabin, the underground structure, and other suitable auxiliary structures.

This section highlights the multi-level and combinable characteristics of the temperature control system. The temperature control device integrates passive heat dissipation, air cooling, active cooling and thermal compensation, and the liquid cooling circuit supports multiple heat exchange methods. Component selection is flexible, and battery module may be arranged as a whole or independently, and are efficiently coupled through thermally conductive or liquid-cooled interfaces, taking into account both heat dissipation efficiency and maintenance flexibility.

Optionally, in the offshore wind power scenarios, the sub-component of the wind turbine may also include a ballast system as needed, which is used to adjust the overall center of gravity and buoyancy distribution of the wind turbine to enhance the stability of the system during operation; the sub-component of the temperature maintaining device may also include a forced ventilation duct and a fan to achieve the purpose of air cooling.

Optionally, the sub-component of the temperature maintaining device may further include a secondary circuit for direct heat dissipation from the external natural cold source, but isolating the external natural cold source from corrosion or other negative effects.

Optionally, the sub-component of the temperature maintaining device may further include a refrigeration system to achieve active cooling.

Optionally, the sub-component of the temperature maintaining device may further include a thermal compensation unit for achieving thermal compensation.

Optionally, any functional unit or its sub-components and secondary components in the low-temperature life extension system may be equipped with a temperature equalization device as needed to improve the overall temperature uniformity and thermal response efficiency of each sub-component.

Optionally, any functional unit or its sub-components and secondary components in the low-temperature life extension system may be equipped with phase change materials as needed to absorb or release heat when the heat load changes abruptly, so as to realize peak shaving and valley filling of thermal management and realize cross-day and cross-seasonal temperature control optimization.

Optionally, the collaborative control module can accurately monitor environmental information and flexibly adjust the multi-level coupling temperature control scheme (including but not limited to adjusting the coupling method or temperature control intensity) to keep the temperature of the battery module always within the low-temperature operating range, but above the dew point to avoid the risk of condensation.

This section emphasizes the depth and refinement of the temperature control system. Diverse thermal management is achieved through ballast systems, forced ventilation, secondary circuits, active cooling and thermal compensation, as well as temperature equalization devices and phase change materials. The collaborative control module links multiple levels of temperature control to ensure temperature stability and prevent condensation, taking into account safety, stability and long life, providing reliable protection for wind power energy storage systems in complex environments.

Optionally, the collaborative control module can also be equipped with a decision control algorithm to realize real-time analysis and calculation of the information collected by the sensor network, and then dynamically optimize the operation sequence or operation mode, operation status and operation intensity of any sub-component or secondary component in the temperature maintaining device as needed, so as to ensure that the temperature of the battery module may be maintained within the low-temperature operating range.

Optionally, any sub-component or secondary component in the temperature maintaining device may be arranged in zones according to the area division of the battery module and work together to achieve synchronous heat dissipation, local temperature control and priority heat dissipation of high-heat areas in each area of the battery module, thereby improving the overall thermal management efficiency.

Optionally, any sub-component or secondary component in the temperature maintaining device can also be integrated with the battery module as needed to achieve a tight combination of heat dissipation structure, forming centralized heat dissipation and overall temperature control, thereby improving the compactness and heat dissipation efficiency of the device.

Optionally, any sub-component or secondary component in the temperature maintaining device may be repeatedly configured as needed to achieve fault redundancy. When some sub-components or secondary components fail, they may be isolated from the fault and then taken over by other sub-components or secondary components to ensure the stability of the overall system.

Optionally, any sub-component or secondary component in the temperature maintaining device may be repeated in parallel as needed to enhance functionality, and may be controlled hierarchically through graded start-stop and graded adjustment, thereby taking into account both energy efficiency and precise control.

Optionally, the temperature maintaining device adopts a modular design concept, wherein any sub-component or secondary component may be used as a modular installation unit as needed, and may be quickly assembled, disassembled, maintained, expanded and upgraded through quick connectors.

This section emphasizes the intelligence and high reliability of the temperature control system. The collaborative control module analyzes sensor data in real time, dynamically adjusts the operating strategy, and the partitioned layout takes into account both global balance and hot spot heat dissipation. Repeated configuration and parallel redundancy improve fault tolerance, and modular design enhances flexibility, realizing intelligent sensing, dynamic control and reliable operation.

Optionally, the specific methods for achieving passive heat dissipation include, but are not limited to, directly conducting heat between the energy storage compartment and the inner wall of the wind turbine tower, concrete foundation or building wall, thereby transferring heat to the structure with a large heat capacity or surface area, and finally dissipating it to the surrounding environment through air convection and radiation on the outer surface of the structure.

Optionally, the forced ventilation duct and fan can promote airflow to the location where heat dissipation is required, enhance the air convection heat transfer effect, and thus provide targeted heat dissipation for any sub-component or secondary component of the battery module or temperature maintaining device.

Optionally, the heat dissipation terminal may be flexibly set in the system interior, external environment or underground foundation according to the system deployment environment and cold source conditions, and cool the coolant in the circuit through direct contact or indirect coupling. The direct contact method allows the heat dissipation terminal to be immersed or exposed to seawater, surface water, soil or flowing air and other natural cold sources to achieve direct heat exchange. The indirect coupling method uses an intermediate heat exchanger to perform isolated heat exchange with the above-mentioned natural cold sources to adapt to the heat dissipation requirements of different corrosiveness, cleanliness and temperature conditions.

Optionally, the secondary components of the secondary circuit include corrosion-resistant pipelines, liquid pumps, and secondary heat exchangers.

Optionally, the secondary circuit introduces seawater, lake water or groundwater as a cooling medium through corrosion-resistant pipelines, and then exchanges heat with the liquid cooling circuit, energy storage compartment or battery module through a secondary heat exchanger. The cooling medium after heat exchange may be discharged back to nature or recycled.

Optionally, the refrigeration system can perform targeted cooling and temperature reduction on any sub-component or secondary component in the temperature maintaining device as needed.

Optionally, the refrigeration system can employ any of the following principles: compressor refrigeration, thermoelectric refrigeration (semiconductor refrigeration), absorption refrigeration, or other refrigeration principles; The refrigeration system can also use a combination of the above-mentioned principles to achieve active refrigeration.

Optionally, the secondary components of the refrigeration system may include a compressor, condenser, throttling device, evaporator, thermoelectric cooling chip, heat sink, DC power module, temperature control drive circuit, generator, absorber, heat exchanger, liquid cooling plate, cooling pump, refrigeration pipeline, control valve and sensor, and may be selected and matched as needed according to different refrigeration principles.

Optionally, the thermal compensation unit may adopt any one of the following thermal compensation principles: positive temperature coefficient (PTC) electric heater, electric heating film, liquid thermal circuit heating device or heat pump device; or thermal compensation may be achieved through a combination of multiple thermal compensation principles.

Optionally, the secondary components of the thermal compensation unit may include heating elements, heat exchange plates or heat exchange pipelines, circulating pumps, heat transfer medium pipelines, heat dissipation and insulation structures, power supply modules, temperature sensors, controllers, actuators, connectors and safety protection components, and may be selected and matched as needed according to different thermal compensation principles.

Optionally, the thermal compensation unit can perform directional thermal compensation on any sub-component or secondary component in the temperature maintaining device as needed.

This section demonstrates the diverse thermal management of the temperature control system. Passive heat dissipation relies on the energy storage compartment, tower, and air convection to release heat, while forced ventilation enhances the heat dissipation effect. The secondary circuit utilizes natural cold sources for isolation or direct heat exchange, and the refrigeration and thermal compensation unit achieves directional temperature control. The overall solution balances efficiency, flexibility, and reliability, reflecting a multi-level thermal management strategy.

Optionally, the collaborative control module can also dynamically adjust, reconstruct, switch, expand, and optimize the topological connection structure and operating status between any sub-component or secondary component in the temperature maintaining device as needed, so as to flexibly adapt to the temperature control requirements under different working conditions.

Optionally, the temperature maintaining device may be configured with controllable connection elements and/or standardized interfaces as needed to support flexible management and system optimization of the collaborative control module.

Optionally, the controllable connection element is used to realize the dynamic adjustment of the topology. The types of controllable connection element include fluid controllable connection elements, thermal controllable connection elements, electrical controllable connection elements, information controllable connection elements, and mechanical controllable connection elements, including but not limited to multi-way valves, flow regulating valves, fluid quick-connect/quick-cut interfaces, and bypass circuits.

Optionally, the standardized interface is used to realize the quick connection and/or hot-swapping of the physical structures; The types of standardized interface include electrical interfaces, fluid interfaces, thermal interfaces, information interfaces and mechanical interfaces, including but not limited to electrical quick-connect plugs, fluid quick-connect/quick-switching interfaces, modular heat-conducting interfaces and modular mounting components.

Optionally, the energy storage compartment adopts a modular sealed shell structure, and an anti-corrosion coating is applied to the outer surface of the energy storage compartment to resist long-term erosion from marine salt spray and high humidity environment, and to ensure the structural integrity and reliability of the energy storage compartment.

Optionally, the energy storage compartment is equipped with a fire suppression and explosion suppression device, including but not limited to an inert gas fire extinguishing agent spray system or a perfluorohexanone fire extinguishing system.

Optionally, the energy storage compartment is equipped with an automatic pressure relief valve and a guide pressure relief channel, which are used to quickly release high-pressure gas and ejected material when the battery experiences thermal runaway and guide them to a safe area.

Optionally, the important areas inside the energy storage compartment are separated by heat-insulated walls to prevent the heat generated by the battery module after thermal runaway from spreading to other areas.

Optionally, the battery module is arranged in a modular combination manner, which can support capacity expansion and technology upgrade, while improving maintainability and operational reliability.

Optionally, the battery module is divided into multiple electrically isolated battery sub-modules, and each battery sub-module is equipped with a disconnect switch or DC circuit breaker When a battery sub-module fails, it may be quickly isolated to prevent the fault from spreading and ensure that the entire battery module continues to operate.

Optionally, The battery module has a standardized interface for quick installation and removal or hot-swapping, and is equipped with automatic identification and parameter synchronization functions, enabling the battery module to be maintained, replaced or expanded without affecting the overall operation of the energy storage compartment; It also supports unattended or semi-automated operation and maintenance, thereby further improving the flexibility and reliability of the system.

This section demonstrates the system's optimizations in intelligent management, safety protection, and modular operation and maintenance. The collaborative control module dynamically adjusts temperature control and energy management, and the energy storage compartment features corrosion-resistant, explosion-proof, and heat-insulating designs. The battery module are modularly partitioned, supporting expansion and rapid fault isolation. Standardized interfaces enhance maintenance convenience, achieving intelligent control, safety assurance, and flexible operation and maintenance.

Optionally, the collaborative control module is connected to the main controller of the wind turbine and the power grid dispatch center to coordinate the power generation of the wind turbine and the charging and discharging process of the battery module, so as to achieve smooth output of power at the grid connection point and support the off-grid operation mode.

Optionally, the collaborative control module is configured to execute one or more of the following working logics: power smoothing logic, low wind speed compensation logic, capacity redundancy logic, and cluster collaborative logic.

Optionally, when the collaborative control module executes the power smoothing logic, if it detects that the power generation fluctuation of the wind turbine exceeds the operating condition threshold, it will control the battery module to charge or discharge in order to smooth the total output power at the grid connection point and meet the fluctuation requirements of the power grid.

Optionally, when the collaborative control module executes the low wind speed compensation logic, if it detects that the wind turbine is operating at low wind speed and the power generation is insufficient to meet external demand, it will control the battery module to discharge in order to maintain a stable and continuous power supply.

Optionally, when the collaborative control module executes the capacity redundancy logic, if the available capacity of the battery module decreases due to the low-temperature operating range and the grid connection demand exceeds the battery module's capacity storage capacity, it will automatically activate capacity redundancy to compensate for power output or reception, ensuring that the capacity is not depleted or overflowed.

Optionally, when the collaborative control module executes the cluster collaborative logic, as a member of the wind farm cluster, it will communicate and cooperate with the collaborative control module of other wind turbines in the cluster, so that multiple battery module can work in coordination, jointly respond to regional dispatch instructions, form a virtual power plant, and provide peak shaving, frequency regulation or reserve capacity services.

Optionally, the collaborative control module has a derating operation logic, when it detects that the battery module capacity has decreased due to a fault, or that part of the cooling capacity of the temperature maintaining device has failed, it can automatically reduce the maximum allowable charging and discharging power of the system, sacrificing some performance to ensure the continuous supply of basic power to the wind turbine.

Optionally, the collaborative control module may be further configured to acquire real-time temperature, health status, and maximum available power or capacity data of the battery module, while also incorporating or accessing weather forecast data and load prediction data, and using model predictive control algorithms to pre-plan the charging and discharging behavior of the battery module and the power output curve of the wind turbine, thereby maximizing wind energy utilization, extending battery module lifespan, or improving grid service revenue, and formulating an optimal power storage scheduling plan accordingly.

This section demonstrates the intelligent energy management and grid adaptation capabilities of the collaborative control module. Through communication with the wind turbine and the grid, it achieves coordinated regulation of power generation and battery charging/discharging, supporting smooth grid connection and disconnection. The module possesses power smoothing, low wind speed compensation, capacity redundancy, and cluster collaboration capabilities. Combined with predictive control, it optimizes charging/discharging and power output to maximize wind energy utilization, extend battery life, and improve economic efficiency.

Optionally, the setting of the low-temperature operating range/operating condition threshold may vary depending on the type, model, chemical system, capacity, rated voltage and operating environment conditions of the battery module.

Optionally, the specific low-temperature operating range/operating condition threshold may be determined through experiments (such as accelerated aging tests, charge-discharge cycle tests, thermal characteristic analysis), empirical data, manufacturer recommendations, or by combining thermal management models, aging models, chemical kinetic simulation predictions, historical operating data statistics, multi-factor combination optimization, and other methods.

Optionally, the upper and lower limits of the low-temperature operating range may be determined according to specific application requirements, including but not limited to selecting from the following listed temperature values as needed (or selecting as needed within a ±2.5° C. range of the following temperature values): −30° C., −25° C., −22.5° C., −20° C., −17.5° C., −15° C., −12.5° C., −10° C., −7.5° C., −5° C., −2.5° C., 0° C., 2.5° C., 5° C., 7.5° C., 10° C., 12.5° C., 15° C., 17.5° C., 20° C., 22.5° C., 25° C., 30° C.

Optionally, the absolute difference between the upper and lower limits of the low-temperature operating range may be determined according to specific application requirements, and is used to limit the width of the life-extending temperature range, including but not limited to selecting from the following values as needed (and also selecting as needed within a ±2.5° C. range of these values): 1° C., 2° C., 3° C., 4° C., 5° C., 10° C., 15° C., 20° C., 25° C., 30° C., 35° C., 40° C.

This section emphasizes the flexibility and customization of low-temperature life extension. The upper and lower temperature limits and life extension range may be adjusted according to the battery type, capacity and environmental conditions. By optimizing the temperature control scheme, the battery life and performance may be balanced, and the operational reliability may be improved.

Optionally, the controllable connection element may be used to dynamically adjust, reconstruct, or switch the topological relationship between any functional unit or its sub-components and secondary components in the low-temperature life extension system as needed, so as to support multi-level coupling, flexible switching, on-demand reconstruction, combination and optimization of the temperature control scheme, and enhance the adaptability of the low-temperature life extension system to different operating conditions and functional expansion requirements.

Optionally, the standardized interface enables the rapid installation, disassembly, interchange, and expansion of any functional unit or its sub-components and secondary components in the low-temperature life extension system, simplifies the maintenance, upgrade, and modular transformation process, improves the maintainability, scalability, and reconfigurability of the low-temperature life extension system, and achieves high modularity and convenience of functional upgrades.

Optionally, the collaborative control module can also dynamically optimize the operating sequence, operating mode or operating status, and operating intensity of any functional unit or its sub-components and secondary components in the low-temperature life extension system as needed; The collaborative control module can also dynamically adjust, reconstruct, switch, expand, or optimize the topological connection structure and operating status between any sub-components or secondary components in the low-temperature life extension system as needed; Any functional unit or its sub-components and secondary components in the low-temperature life extension system can also be configured with controllable connection elements and/or standardized interfaces as needed to support the flexible management and system optimization of the collaborative control module.

Optionally, any functional unit or its sub-component or secondary component of the low-temperature life extension system may be arranged independently or in groups at any part of the wind turbine as needed, including but not limited to the inside or outside of the tower, the interior of the nacelle, the foundation platform, the wind turbine blade hub and the nearby ground, and may be coupled, integrated or independently suspended with the original structure of the wind turbine; at the same time, modular interchangeability, zoned collaborative control and multi-point redundant arrangement may be realized to take into account system performance, maintenance safety and thermal management efficiency.

This section highlights the system's advantages in modularity, reconfigurability, and flexible layout. Controllable connection elements and standardized interfaces support module interchangeability, rapid installation, and topology reconfiguration, enabling collaborative control and optimized operation strategies. Functional units may be arranged as needed to achieve partitioned collaboration, multi-point redundancy, and balance performance, maintenance, and thermal management efficiency.

Optionally, the low-temperature operating range is about 10° C.; the low-temperature operating range can also be about 15° C.; the low-temperature operating range can also be about 20° C.

Optionally, the battery module may be arranged inside the wind turbine tower, while the heat dissipation terminal of the temperature maintaining device may be arranged outside the tower. The battery module and the heat dissipation terminal achieve heat transfer through heat conduction pipes passing through the tower wall.

Optionally, when the wind turbine is an offshore wind turbine, the heat dissipation terminal of the temperature maintaining device may be configured as a seawater heat exchanger coupled to the outer wall of the tower, or a seawater heat exchanger made of corrosion-resistant material and immersed in seawater.

Optionally, the heat-conducting pipeline connecting the battery module and the temperature maintaining device adopts a fluid quick-connect/quick-cut interface and a modular valve design to support rapid isolation and disassembly during maintenance.

Optionally, the battery module can also be deployed outside the wind turbine, including the base platform, the nacelle perimeter or the ground auxiliary cabin, and may be flexibly connected and coordinated with the temperature maintaining device, the wind turbine and the collaborative control module through a modular interface.

This section emphasizes the flexible arrangement and thermal management of the battery module and temperature control device. The low-temperature range is adjustable, and the heat dissipation is achieved by combining heat conduction pipes and seawater heat exchangers inside and outside the tower. The modular interface facilitates maintenance and quick connection. The module can also be deployed outside the wind turbine to achieve efficient collaboration and adapt to various operating conditions.

Optionally, the phase change material may be arranged in a hierarchical array or deployed in different locations in a hierarchical manner to achieve a hierarchical phase change process through a combination of multiple melting points, and store and release cold energy at different temperature points or different locations, thereby enhancing the ability to maintain and regulate low-temperature; the phase change material is composed of microcapsules or polymer composite materials encapsulating the phase change material, and is specifically deployed in the form of encapsulation, filling or forming a plate.

Optionally, the melting point of the phase change material may be precisely set according to actual needs, and adjusted as needed within the low-temperature operating range, including but not limited to precise control of the melting point through alloy formulation optimization or microcapsule encapsulation technology and other methods.

Optionally, the multi-way valve is used to change the path of the fluid to achieve flexible switching of the flow path.

Optionally, the flow regulating valve is used to precisely control the flow rate and flow of the fluid to achieve stepless adjustment of the cooling intensity.

Optionally, the fluid quick-connect/quick-disconnect interface is used for quick connection and disconnection of the fluid circuit, or to realize quick switching of the flow path in an instant, thereby ensuring rapid response and switching of the cooling mode.

Optionally, the bypass loop is used to provide a backup or diversion path to enhance the redundancy and reliability of the system.

Optionally, the electrical quick-connect plug is used to realize hot-swapping of electrical connection; the modular heat-conducting interface is used to realize thermal contact and efficient heat exchange between different modules; the modular mounting component is used to realize mechanical fixation and quick disassembly.

This section emphasizes the refined design of the low-temperature life extension system. Sensor networks collect operational and environmental data to assist in coordinated control. Phase change materials are used for graded cold storage to enhance temperature control stability. Multi-way valves, quick-connect interfaces, and bypass circuits provide fluid switching and redundancy assurance, while modular interfaces improve assembly and maintenance efficiency, achieving efficient, flexible, and maintainable system characteristics.

Optionally, the anti-vibration structure may be selected from one or more of the following combinations: elastic damping bearing, buffer pad, damping component, suspension support structure, vibration isolation cavity, flexible connector, gradient stiffness support, viscoelastic damping material, friction damping unit, fluid damper, pneumatic adjustment cavity, magnetic levitation vibration isolator, shape memory alloy support, electronically controlled intelligent damper, liquid-gas hybrid vibration isolation system and multi-layer suspension platform.

Optionally, the ballast system includes a ballast water tank and a buoyancy chamber.

Optionally, the ballast water tank can achieve ballast adjustment by filling and draining water. Its sub-components may include water pumps, pipelines, valves and liquid level sensors for controlling the inflow and outflow of water and accurately monitoring the water volume.

Optionally, the buoyancy chamber can change buoyancy by filling and discharging gas, and its sub-components may include a compressor, a gas storage tank, an air inlet and outlet valve and a pressure sensor for controlling the inlet and outlet of gas and maintaining pressure in the chamber.

Optionally, the ballast system can interact with the collaborative control module to dynamically adjust the ballast tank and buoyancy chamber based on the attitude information, external environmental parameters and operating conditions collected by the sensor network, so as to improve the system's anti-disturbance capability and operational safety.

Optionally, the heating object of the thermal compensation unit may be flexibly configured according to actual thermal management needs, including but not limited to battery module, liquid cooling circuits, energy storage compartments or liquid cooling plates that are in thermal contact with battery module, so as to provide effective heating effects in low-temperature environments, rapid heating, emergency heat preservation and other scenarios.

Optionally, the cooling object of the refrigeration system may be flexibly configured according to actual thermal management needs, including but not limited to battery module, liquid cooling circuits, energy storage compartments or liquid cooling plates that are in thermal contact with battery module, thereby providing enhanced cooling capabilities in high-temperature environments, high-rate operation, emergency heat dissipation needs and other scenarios.

This section highlights the multi-level flexibility of the low-temperature life extension system in vibration control, buoyancy adjustment and thermal management. The anti-vibration structure reduces the impact of operating vibration, the ballast system dynamically adjusts the center of gravity and buoyancy, and the thermal compensation and refrigeration system flexibly manages the temperature to ensure stable and efficient operation of the system in complex environments.

### BRIEF DESCRIPTION OF DRAWINGS

To more clearly illustrate the technical solutions in the embodiments of the present invention, the drawings used in the embodiments will be briefly introduced below. Obviously, the drawings described below are only some preferred embodiments of the present invention. For those skilled in the art, other drawings may be obtained based on these drawings without creative effort.

FIG. 1 is a schematic diagram of a low-temperature life extension system for wind turbine coupled energy storage according to an embodiment of the present invention.

FIG. 2 is another schematic diagram of a low-temperature life extension system for wind turbine coupled energy storage according to an embodiment of the present invention.

FIG. 3 is another schematic diagram of a low-temperature life extension system for wind turbine coupled energy storage according to an embodiment of the present invention.

FIG. 4 is another schematic diagram of a low-temperature life extension system for wind turbine coupled energy storage according to an embodiment of the present invention.

FIG. 5 is another schematic diagram of a low-temperature life extension system for wind turbine coupled energy storage according to an embodiment of the present invention.

FIG. 6 is another schematic diagram of a low-temperature life extension system for wind turbine coupled energy storage according to an embodiment of the present invention.

FIG. 7 is another schematic diagram of a low-temperature life extension system for wind turbine coupled energy storage according to an embodiment of the present invention.

FIG. 8 is another schematic diagram of a low-temperature life extension system for wind turbine coupled energy storage according to an embodiment of the present invention.

FIG. 9 shows the original experimental data to demonstrate the low-temperature life extension effect of this case.

The following components are shown in the figure: battery module 101, temperature maintaining device 201, wind turbine 301, collaborative control module 401, tower 311, energy storage compartment 121, battery 111, heat dissipation terminal 211, liquid pump 221, liquid cooling plate 231, cooling pipe 241, heat exchanger 251, refrigeration pipe 510, evaporator 511, expansion valve 512, condenser 513, compressor 514, and seawater 601.

### DETAILED DESCRIPTION OF THE INVENTION

Several embodiments of the present invention will now be described in detail with reference to the accompanying drawings. It should be understood that the described embodiments are only for illustrating the present invention and are not intended to limit the scope of protection of the present invention. Those skilled in the art can make other implementations based on the teachings of the present invention without creative effort.

It should be understood that the system architecture, functional modules and their interconnections disclosed in this disclosure are merely illustrative examples, and the embodiments shown in the specification and drawings do not limit the scope of protection. In different application scenarios, the form, quantity, position, connection method and materials of related components, other functional units, sub-components and secondary components may be replaced, equivalently adjusted or recombined according to actual needs. Any adjustments and improvements made to the system structure, control logic, functional division or operation mode without departing from the core technical ideas of this disclosure shall fall within the protection scope of this disclosure.

The logical relationships and functional divisions among the battery module, temperature control device, collaborative control module, wind power generation unit, and other functional units, sub-components, and secondary components described in this disclosure do not imply that they must exist in a physically separate manner in actual implementation. Some functions may be implemented by software or integrated in a single hardware platform; similarly, a single function can also be completed collaboratively by multiple hardware units or other sub-components. Different implementation forms, component numbers, arrangement methods, connection methods, or characteristic variables may be flexibly changed according to actual needs without affecting the realization of the technical effects of this disclosure.

The numerical ranges, operating conditions, and application environments mentioned in this disclosure are preferred embodiments or reference values and do not constitute strict limitations. Under different regions, ambient temperatures, fan types, battery specifications, or service life targets, the relevant parameters may be reasonably optimized, and the adjustment methods and ranges should be considered to fall within the protection scope of this disclosure.

The specific technical features described in this disclosure may be used alone or in combination with other technical features, functional units, sub-components, or secondary components. Although the specification describes low-temperature life extension strategies, battery module and wind turbine co-operation and collaborative control schemes in conjunction with specific embodiments, the core of these contents lies in “using low-temperature to extend battery life and realize the coupled use of energy storage system”. As long as the scheme realizes this core idea, it should be protected and should not be limited by the specific implementation method, component replacement or parameter difference.

Those skilled in the art can make further modifications, replacements or optimizations in terms of system configuration, energy type, coupling method, thermal management strategy, operation control mechanism, component arrangement, material selection and control strategy under the guidance of this disclosure. Any of the above modifications will not affect the substantive content of the technical solution disclosed and should be regarded as falling within the protection scope of this disclosure.

In summary, the embodiments provided in this disclosure are merely illustrative of the technical solutions, intended to help understand their technical principles and possible implementation methods, and are not intended to limit the scope of protection. Any equivalent substitutions, extensions, or improvements made based on the core ideas of this disclosure, including substitutions or optimizations of other functional units, sub-components, and secondary components, shall be protected.

The present invention discloses a low-temperature life extension system for wind turbine coupled energy storage.

FIGS. 1-8 are schematic diagrams of a low-temperature life extension system for wind turbine coupled energy storage according to some embodiments of the present disclosure; in some embodiments, the system is characterized in that:
The low-temperature life extension system includes several functional units, sub-components and secondary components. The functional units may include, but are not limited to, battery module 101, temperature maintaining device 201, wind turbine 301 and collaborative control module 401.
The battery module 101 is used to store electrical energy generated by the wind turbine 301.
The temperature maintaining device 201 can regulate the temperature of the battery module 101 and maintain it within the low-temperature operating range to achieve the purpose of extending battery life at low-temperatures.
The wind turbine 301 is used to convert wind energy into electrical energy and interact with the battery module 101.
The collaborative control module 401 can acquire the operating status and external environment information of each functional unit in the low-temperature life extension system, and perform collaborative optimization control of each functional unit in the low-temperature life extension system in conjunction with the decision control algorithm.
The low-temperature operating range is a range of temperatures above the dew point but below room temperature. When the battery module 101 is used for a long time within the low-temperature operating range, the aging or degradation of electrode materials and electrolytes will be effectively delayed, significantly extending the life of the battery module 101, thereby improve the economic efficiency of the entire life cycle.
Any functional unit or its sub-components and secondary components of the low-temperature life extension system may be selected with anti-vibration structures as needed to suppress vibrations and shocks generated during operation;
The temperature maintaining device is designed to actively promote a decrease in temperature (to extend service life), rather than being used solely to prevent thermal runaway in the traditional sense.
The functional unit refers to the overall module used to realize the main function in the low-temperature life extension system. The sub-component refers to the subdivided structure or independently operable component under the functional unit. The secondary component refers to the specific element or hardware component after further subdivision of the sub-component.

The “room temperature” referred to in this invention refers to the preset environmental reference temperature in the application scenario. This temperature may be selected as needed according to different actual conditions and is not limited to a single value. For example, under certain experimental conditions, the room temperature may be set to about 20° C., while in other application environments, 25° C. or 30° C. may be selected as the room temperature. The “dew point” refers to the temperature at which water vapor in the air begins to condense under corresponding environmental pressure and humidity conditions, which may be determined by existing dew point calculation methods. Therefore, the “low-temperature operating range” referred to in this invention refers to the temperature range that is lower than the selected room temperature but higher than the corresponding dew point temperature. For example, when the relative humidity of the environment is 60% and the room temperature is set to 25° C., the dew point temperature is about 16° C., then the low-temperature operating range is 16° C. to 25° C. Through the above definition, those skilled in the art can select the room temperature according to the specific application environment and determine the low-temperature operating range accordingly, thereby ensuring the feasibility and clarity of this invention.

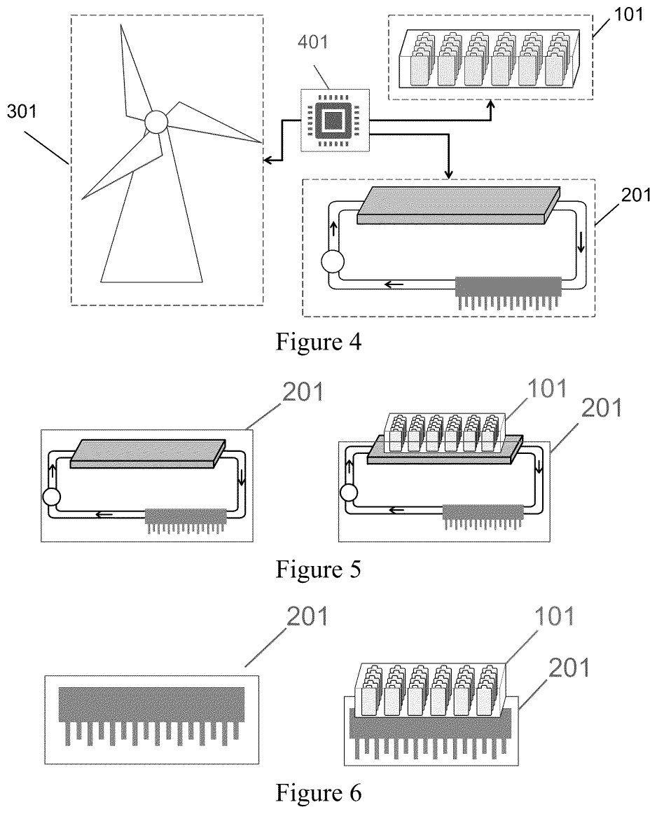

FIG. 4 shows the collaborative control relationship between the collaborative control module 401 and the battery module 101, the temperature maintaining device 201, and the wind turbine 301.

Optionally, the functional units, sub-components and secondary components of the low-temperature life extension system may be selected and configured as needed; wherein the electrical parts adopt a sealed structure to suppress condensation and enhance the system's adaptability to low-temperature environments.

Optionally, the collaborative control module can ensure that one or more characteristic variables of the battery module do not exceed the operating condition threshold during charging and discharging, thereby avoiding damage to the battery module due to excessively high side reaction rates under adverse conditions; the characteristic variables include charging current.

Optionally, the characteristic variables may also include one or more of the following: charging voltage, discharging voltage, discharging current, charging and discharging power, temperature, and other battery operating parameters.

Optionally, when the collaborative control module detects that one or more characteristic variables are close to or exceed the operating condition threshold, the collaborative control module will activate protection measures; the forms of protection measures include reducing charging current, reducing discharging current, limiting power or voltage, cutting off the charging and discharging circuit, and issuing an alarm signal.

Optionally, when the battery module operates in the low-temperature operating range, although the battery module's lifespan may be extended, its initial capacity will be reduced due to the decrease in the electrochemical reaction rate; therefore, the battery module can also be configured with a capacity redundancy function.

Optionally, the capacity redundancy function compensates for the negative impact of low-temperature environment on the capacity of the battery module by reserving additional capacity in advance; the capacity redundancy function is an optional configuration.

Optionally, the temperature maintaining device can adopt a passive heat dissipation strategy as needed to reduce heat dissipation energy consumption.

Optionally, the collaborative control module also integrates the functions of a battery management system, including but not limited to monitoring and managing the operating status of the battery module, balancing the voltage and capacity of each individual cell in the battery module, and interacting with any sub-component or secondary component in the temperature maintaining device to achieve collaborative and optimized energy management.

Optionally, the capacity redundancy function is achieved by adding an auxiliary battery pack to the battery module and operating it in coordination, or by designing the total capacity of the battery module according to a preset redundancy ratio, so that the actual total capacity exceeds the requirements of the application scenario to achieve redundancy.

Optionally, the capacity redundancy function can selectively enable or disable the auxiliary battery pack or automatically adjust the overall operating intensity of the battery module according to the external load demand, so that the total capacity of the battery module can flexibly meet the external load demand and can respond in time when the demand suddenly increases.

Optionally, the capacity redundancy function can not only compensate for the capacity loss of the battery module in the low-temperature life extension range, but also further improve the life of the battery module on the basis of the life extension caused by low-temperature.

Optionally, the sub-components of the collaborative control module include a sensor network, which monitors on demand the characteristic variables of any functional unit or its sub-components, and secondary components of the low-temperature life extension system, along with external environmental parameters. For example, the sensor network can not only collect characteristic variables of wind turbines or battery module, but also collect external environmental parameters such as ambient temperature, humidity, wind speed, air pressure, and light intensity.

Optionally, when applied in offshore wind power scenarios, the battery module can also serve as a counterweight, partially or completely replacing the original counterweight components of the wind turbine, thereby achieving structural reuse and cost savings.

Optionally, any functional unit or any sub-component or secondary component of the low-temperature life extension system has high flexibility in spatial arrangement and may be optimized and deployed according to wind farm environmental conditions, temperature control requirements, maintenance convenience, wind turbine structural constraints, airflow channels, local temperature control optimization, heat load balance, vibration isolation requirements, electrical circuit layout, load bearing capacity, maintenance strategy, and ease of installation and replacement.

Optionally, the battery module may not serve as a counterweight and may not be used as a counterweight component of the wind turbine. Instead, it may be arranged as a pure battery module in the empty space inside the tower or on the tower base platform to adapt to different wind turbine structures and installation requirements.

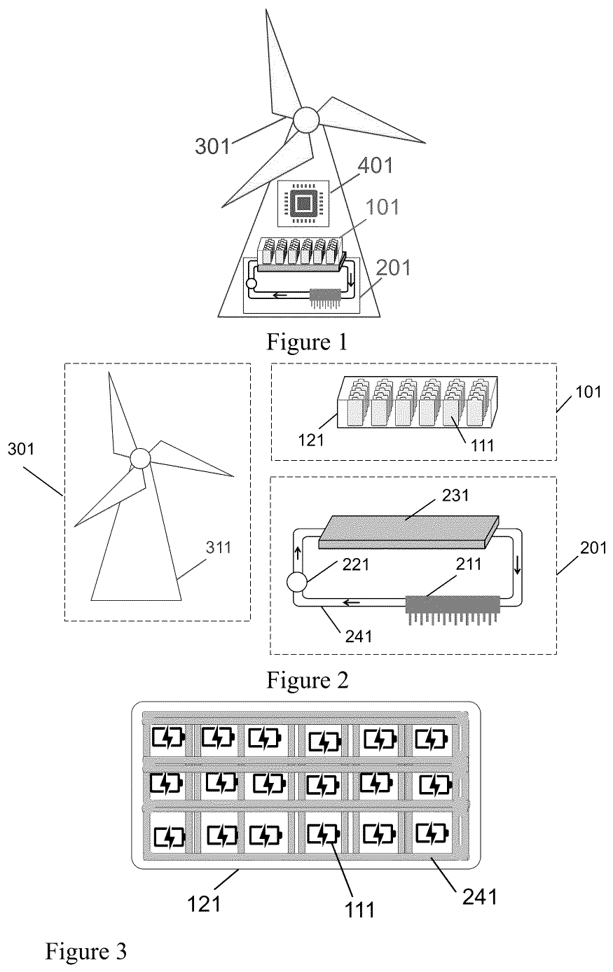

The embodiment in FIG. 2 shows the structural relationship between the tower 311 and the wind turbine 301. The embodiment in FIG. 1 shows that the battery module 101, the temperature maintaining device 201, and the collaborative control module 401 are all arranged inside the tower 311 of the wind turbine 301.

Optionally, the size, mass, center of gravity distribution, and deployment position of the battery module may be optimized and customized according to the rated power, rotor length, tower height and structural characteristics of the wind turbine to meet the overall center of gravity and stability requirements of the wind turbine.

Optionally, the battery module may be arranged in any of the following ways: inside the wind turbine tower; inside the wind turbine nacelle; in an independent energy storage compartment adjacent to the wind turbine; or near the centralized control station or collection line node of the wind farm.

Optionally, the sub-components of the battery module include a battery, an energy storage compartment and a modular interface. The embodiment in FIG. 2 illustrates the structural containment relationship between the energy storage compartment 121 and the battery 111.

Optionally, the energy storage compartment is a shell structure used for the battery module and provides sealing and protection.

Optionally, the modular interface is used to enable the expansion, replacement or maintenance of the battery module.

The low-temperature life extension effect of the present invention is illustrated by an example: Under normal operating conditions with an ambient temperature of 30° C., the rated capacity of the energy storage battery unit coupled to the wind turbine is set to 10 Ah, and the corresponding cumulative charge-discharge life is about 10,000 Ah, which is equivalent to 1,000 cycles (10,000 Ah÷10 Ah). When the battery unit operates in the low-temperature life extension range of about 10° C., thanks to the low-temperature life extension mechanism, its cumulative charge-discharge life may be increased to about 3 times, that is, 30,000 Ah. However, at the same time, the battery capacity will decrease by about 15%, from the original 10 Ah to 8.5 Ah (10 Ah×0.85), and the equivalent cycle number is about 3,529 cycles (30,000 Ah÷8.5 Ah).

It may be seen that although low-temperature operation results in about 15% capacity decay, the battery life is increased to more than three times that under normal temperature conditions, resulting in significant overall benefits. This operating mode, which sacrifices a small amount of capacity in exchange for a multiple increase in lifespan, unexpectedly achieves a “highly profitable” effect. Considering the fluctuating characteristics of wind power generation, the capacity loss caused by low-temperature may be offset by the energy replenishment of the wind turbine when it has surplus power, while the multiple increase in lifespan is of decisive significance for ensuring the long-term stability and economy of the energy storage system.

For example, considering the combined effect of low-temperature life extension and capacity redundancy: if the number of cells in the energy storage battery unit is increased, the initial capacity is increased by 1.1765 times, i.e., 11.765 Ah, then under normal temperature conditions, its cumulative charge-discharge life is correspondingly increased to 11,765 Ah (11.765 Ah×1000 cycles). When it is running in the low-temperature life extension range of about 10° C., although there is a 15% capacity decrease, its effective capacity is still maintained at 10 Ah (11.765 Ah×0.85) because the pre-set redundant capacity can compensate for it. Under the effect of low-temperature life extension, its cumulative charge-discharge life is further extended to 35,290 Ah (11.765 Ah×3), corresponding to an equivalent cycle count of 3529 (35,290 Ah÷10 Ah).

Therefore, by simply adding 1.765 Ah of redundant configuration, the adverse effects of capacity decay may be avoided in low-temperature operation scenarios, while the lifespan may be extended to 3.529 times that of the original, unexpectedly achieving a technological advancement that “turns decay into magic”.

Furthermore, the capacity redundancy configuration not only compensates for the capacity reduction, but also forms a superimposed effect based on the low-temperature life extension mechanism, thereby achieving a higher life extension effect. For example, without redundant capacity (Scenario 1), the cumulative charge-discharge life of the energy storage battery module in the low-temperature life extension range may be increased from 10,000 Ah at room temperature to about 30,000 Ah, which is extended by 3 times. With redundant capacity (Scenario 2), the cumulative charge-discharge life may be further increased to about 35,290 Ah, which is about 0.529 times more than Scenario 1. This shows that the synergistic effect of capacity redundancy and low-temperature life extension can generate additional benefits in terms of life extension.

In the low-temperature life extension effect described in this invention, the life index is not limited to the cumulative charge and discharge amount, but may also include, but is not limited to, the cumulative charge amount, cumulative discharge power, total charge and discharge time, number of cycles, equivalent number of cycles, or the cumulative amount of actual work generated by the battery module for the operation of power-consuming equipment, etc.

It should be emphasized that the numerical values and calculations mentioned above are all examples for illustration and are intended to explain the technical principles of the present invention. They do not constitute a limitation on the scope of protection of the present invention.

Optionally, the temperature maintaining device may use any of the following temperature control methods: passive heat dissipation, air cooling, convection cooling, active cooling and thermal compensation. Alternatively, two or more of these methods may be combined to construct a multi-level coupling temperature control scheme to meet the needs of different environmental conditions and heat loads. At the same time, the temperature maintaining device may be configured with corresponding sub-components according to actual needs to achieve the required temperature control method.

Optionally, the energy storage compartment can achieve passive heat dissipation by being in close contact with the structure of the wind turbine and utilizing its thermal conductivity and heat dissipation characteristics.

Optionally, the sub-component of the temperature maintaining device may further include a liquid cooling circuit to achieve convective heat dissipation.

Optionally, the liquid cooling circuit can adopt any of the following methods: plate liquid cooling, tube liquid cooling, microchannel liquid cooling, immersion liquid cooling, sandwich liquid cooling or shell integrated liquid cooling, or a combination of multiple methods to achieve heat exchange of the battery module.

Optionally, the secondary components of the liquid cooling circuit may include liquid cooling plates, cooling pipes, serpentine pipes, coils, microchannel cooling plates, jacketed cooling fins, liquid cooling shells, liquid pumps, heat exchangers, heat dissipation terminals, control valves, sensors, and coolant storage tanks, and may be freely selected and flexibly combined according to different liquid cooling requirements and design schemes.

The embodiment in FIG. 3 shows that the battery 111 and the cooling pipe 241 are in close contact and are placed together in the energy storage compartment 121.

Optionally, the battery module can directly contact the temperature maintaining device or any of its sub-components or secondary components as needed to achieve efficient thermal coupling.

Optionally, the battery module may be physically integrated with the temperature maintaining device or any of its sub-components or secondary components as needed to form a unified and indivisible functional unit.

Optionally, the battery module and the temperature maintaining device or any of its sub-components or secondary components can also be arranged relatively independently and separately, and efficient thermal coupling may be achieved through flexible heat conduction pipes, liquid cooling circuits or thermal conduction interfaces, so that they may be flexibly deployed according to the wind turbine structure, environmental conditions and maintenance strategies.

Optionally, the battery module or the temperature maintaining device may be installed as needed in the tower of the wind turbine, the surrounding structure of the tower, the interior of the nacelle, the foundation platform, the ground auxiliary cabin, the underground structure, and other suitable auxiliary structures.

Optionally, in the offshore wind power scenarios, the sub-component of the wind turbine may also include a ballast system as needed, which is used to adjust the overall center of gravity and buoyancy distribution of the wind turbine to enhance the stability of the system during operation; the sub-component of the temperature maintaining device may also include a forced ventilation duct and a fan to achieve the purpose of air cooling.

Optionally, the sub-component of the temperature maintaining device may further include a secondary circuit for direct heat dissipation from the external natural cold source, but isolating the external natural cold source from corrosion or other negative effects.

Optionally, the sub-component of the temperature maintaining device may further include a refrigeration system to achieve active cooling.

Optionally, the sub-component of the temperature maintaining device may further include a thermal compensation unit for achieving thermal compensation.

Optionally, any functional unit or its sub-components and secondary components in the low-temperature life extension system may be equipped with a temperature equalization device as needed to improve the overall temperature uniformity and thermal response efficiency of each sub-component.

Optionally, any functional unit or its sub-components and secondary components in the low-temperature life extension system may be equipped with phase change materials as needed to absorb or release heat when the heat load changes abruptly, so as to realize peak shaving and valley filling of thermal management and realize cross-day and cross-seasonal temperature control optimization.

Optionally, the collaborative control module can accurately monitor environmental information and flexibly adjust the multi-level coupling temperature control scheme (including but not limited to adjusting the coupling method or temperature control intensity) to keep the temperature of the battery module always within the low-temperature operating range, but above the dew point to avoid the risk of condensation.

Optionally, the collaborative control module can also be equipped with a decision control algorithm to realize real-time analysis and calculation of the information collected by the sensor network, and then dynamically optimize the operation sequence or operation mode, operation status and operation intensity of any sub-component or secondary component in the temperature maintaining device as needed, so as to ensure that the temperature of the battery module may be maintained within the low-temperature operating range.

Optionally, any sub-component or secondary component in the temperature maintaining device may be arranged in zones according to the area division of the battery module and work together to achieve synchronous heat dissipation, local temperature control and priority heat dissipation of high-heat areas in each area of the battery module, thereby improving the overall thermal management efficiency.

Optionally, any sub-component or secondary component in the temperature maintaining device can also be integrated with the battery module as needed to achieve a tight combination of heat dissipation structure, forming centralized heat dissipation and overall temperature control, thereby improving the compactness and heat dissipation efficiency of the device.

Optionally, any sub-component or secondary component in the temperature maintaining device may be repeatedly configured as needed to achieve fault redundancy. When some sub-components or secondary components fail, they may be isolated from the fault and then taken over by other sub-components or secondary components to ensure the stability of the overall system.

Optionally, any sub-component or secondary component in the temperature maintaining device may be repeated in parallel as needed to enhance functionality, and may be controlled hierarchically through graded start-stop and graded adjustment, thereby taking into account both energy efficiency and precise control.

Optionally, the temperature maintaining device adopts a modular design concept, wherein any sub-component or secondary component may be used as a modular installation unit as needed, and may be quickly assembled, disassembled, maintained, expanded and upgraded through quick connectors.

Optionally, the specific methods for achieving passive heat dissipation include, but are not limited to, directly conducting heat between the energy storage compartment and the inner wall of the wind turbine tower, concrete foundation or building wall, thereby transferring heat to the structure with a large heat capacity or surface area, and finally dissipating it to the surrounding environment through air convection and radiation on the outer surface of the structure.

Optionally, the forced ventilation duct and fan can promote airflow to the location where heat dissipation is required, enhance the air convection heat transfer effect, and thus provide targeted heat dissipation for any sub-component or secondary component of the battery module or temperature maintaining device.

Optionally, the heat dissipation terminal may be flexibly set in the system interior, external environment or underground foundation according to the system deployment environment and cold source conditions, and cool the coolant in the circuit through direct contact or indirect coupling. The direct contact method allows the heat dissipation terminal to be immersed or exposed to seawater, surface water, soil or flowing air and other natural cold sources to achieve direct heat exchange. The indirect coupling method uses an intermediate heat exchanger to perform isolated heat exchange with the above-mentioned natural cold sources to adapt to the heat dissipation requirements of different corrosiveness, cleanliness and temperature conditions.

Optionally, the secondary components of the secondary circuit include corrosion-resistant pipelines, liquid pumps, and secondary heat exchangers.

Optionally, the secondary circuit introduces seawater, lake water or groundwater as a cooling medium through corrosion-resistant pipelines, and then exchanges heat with the liquid cooling circuit, energy storage compartment or battery module through a secondary heat exchanger. The cooling medium after heat exchange may be discharged back to nature or recycled.

The embodiment in FIG. 2 shows a typical case of a liquid cooling circuit, in which the liquid pump 221 drives the coolant to flow in the cooling pipe 241, flows through the liquid cooling plate 231 to carry away heat, and then releases the heat to the outside through the heat dissipation terminal 211, and the cycle repeats. The embodiment in FIG. 5 shows that the temperature maintaining device 201 uses a liquid cooling circuit to achieve the purpose of convective heat dissipation; it also shows the coupling relationship between the temperature maintaining device 201 and the battery module 101, that is, heat is dissipated through the contact between the liquid cooling plate and the battery module 101, and then the cooling medium transfers the heat to the heat dissipation terminal through the cooling pipe.

In the liquid cooling circuit, the cooling medium used may be deionized water, softened water, ethylene glycol-water solution, propylene glycol-water solution, glycerol-water solution, silicone oil, mineral oil, synthetic heat transfer oil, fluorinated liquid (such as 3MNovec or Fluorinert), dielectric coolant (such as PAO polyalkylbenzene), phase change liquid, nanofluid, salt solution, or other liquids with thermal conductivity and electrical insulation. The above cooling media may be used in different environments. Among them, water and alcohol solutions are suitable for conventional scenarios, silicone oil, mineral oil, and synthetic heat transfer oil are suitable for scenarios with high temperature or high electrical insulation requirements, while fluorinated liquid, dielectric coolant, and nanofluid are suitable for applications with high safety or extreme climatic conditions.

The embodiment in FIG. 6 shows that the temperature maintaining device 201 uses a heat dissipation terminal to achieve the purpose of passive heat dissipation. It also shows the coupling relationship between the temperature maintaining device 201 and the battery module 101, that is, heat dissipation is achieved by contacting the heat dissipation terminal with the battery module 101.

Optionally, the refrigeration system can perform targeted cooling and temperature reduction on any sub-component or secondary component in the temperature maintaining device as needed.

Optionally, the refrigeration system can employ any of the following principles: compressor refrigeration, thermoelectric refrigeration (semiconductor refrigeration), absorption refrigeration, or other refrigeration principles; The refrigeration system can also use a combination of the above-mentioned principles to achieve active refrigeration.

Optionally, the secondary components of the refrigeration system may include a compressor, condenser, throttling device, evaporator, thermoelectric cooling chip, heat sink, DC power module, temperature control drive circuit, generator, absorber, heat exchanger, liquid cooling plate, cooling pump, refrigeration pipeline, control valve and sensor, and may be selected and matched as needed according to different refrigeration principles.

The embodiment in FIG. 8 shows that the temperature maintaining device 201 adopts a multi-stage coupled temperature control scheme by using a liquid cooling circuit and a refrigeration circuit in synergy. The liquid cooling circuit consists of a liquid cooling plate 231, a cooling pipe 241, and a heat exchanger 251. The liquid cooling plate 231 may be used to attach to the battery module to absorb heat (not shown), and the coolant transfers the heat to the heat exchanger 251. The refrigeration circuit consists of a refrigeration pipe 510, an evaporator 511, an expansion valve 512, a condenser 513, and a compressor 514. The evaporator 511 absorbs heat from the liquid cooling circuit, and the compressor 514 compresses the heat and dissipates it through the condenser 513 placed in seawater 601. It should be noted that the liquid cooling circuit and the refrigeration circuit can operate flexibly according to the actual load requirements of the battery module. They can work simultaneously or one of them can operate alone to achieve the best temperature control effect and energy efficiency optimization.

Optionally, the thermal compensation unit may adopt any one of the following thermal compensation principles: positive temperature coefficient (PTC) electric heater, electric heating film, liquid thermal circuit heating device or heat pump device; or thermal compensation may be achieved through a combination of multiple thermal compensation principles.

Optionally, the secondary components of the thermal compensation unit may include heating elements, heat exchange plates or heat exchange pipelines, circulating pumps, heat transfer medium pipelines, heat dissipation and insulation structures, power supply modules, temperature sensors, controllers, actuators, connectors and safety protection components, and may be selected and matched as needed according to different thermal compensation principles.

Optionally, the thermal compensation unit can perform directional thermal compensation on any sub-component or secondary component in the temperature maintaining device as needed.

Optionally, the collaborative control module can also dynamically adjust, reconstruct, switch, expand, and optimize the topological connection structure and operating status between any sub-component or secondary component in the temperature maintaining device as needed, so as to flexibly adapt to the temperature control requirements under different working conditions.

Optionally, the temperature maintaining device may be configured with controllable connection elements and/or standardized interfaces as needed to support flexible management and system optimization of the collaborative control module.

Optionally, the controllable connection element is used to realize the dynamic adjustment of the topology. The types of controllable connection element include fluid controllable connection elements, thermal controllable connection elements, electrical controllable connection elements, information controllable connection elements, and mechanical controllable connection elements, including but not limited to multi-way valves, flow regulating valves, fluid quick-connect/quick-cut interfaces, and bypass circuits.

Optionally, the standardized interface is used to realize the quick connection and/or hot-swapping of the physical structures; The types of standardized interface include electrical interfaces, fluid interfaces, thermal interfaces, information interfaces and mechanical interfaces, including but not limited to electrical quick-connect plugs, fluid quick-connect/quick-switching interfaces, modular heat-conducting interfaces and modular mounting components.

Optionally, the energy storage compartment adopts a modular sealed shell structure, and an anti-corrosion coating is applied to the outer surface of the energy storage compartment to resist long-term erosion from marine salt spray and high humidity environment, and to ensure the structural integrity and reliability of the energy storage compartment.

Optionally, the energy storage compartment is equipped with a fire suppression and explosion suppression device, including but not limited to an inert gas fire extinguishing agent spray system or a perfluorohexanone fire extinguishing system.

Optionally, the energy storage compartment is equipped with an automatic pressure relief valve and a guide pressure relief channel, which are used to quickly release high-pressure gas and ejected material when the battery experiences thermal runaway and guide them to a safe area.

Optionally, the important areas inside the energy storage compartment are separated by heat-insulated walls to prevent the heat generated by the battery module after thermal runaway from spreading to other areas.

Optionally, the battery module is arranged in a modular combination manner, which can support capacity expansion and technology upgrade, while improving maintainability and operational reliability.

Optionally, the battery module is divided into multiple electrically isolated battery sub-modules, and each battery sub-module is equipped with a disconnect switch or DC circuit breaker. When a battery sub-module fails, it may be quickly isolated to prevent the fault from spreading and ensure that the entire battery module continues to operate.

Optionally, The battery module has a standardized interface for quick installation and removal or hot-swapping, and is equipped with automatic identification and parameter synchronization functions, enabling the battery module to be maintained, replaced or expanded without affecting the overall operation of the energy storage compartment; It also supports unattended or semi-automated operation and maintenance, thereby further improving the flexibility and reliability of the system.

Optionally, the collaborative control module is connected to the main controller of the wind turbine and the power grid dispatch center to coordinate the power generation of the wind turbine and the charging and discharging process of the battery module, so as to achieve smooth output of power at the grid connection point and support the off-grid operation mode.

Optionally, the collaborative control module is configured to execute one or more of the following working logics: power smoothing logic, low wind speed compensation logic, capacity redundancy logic, and cluster collaborative logic.

Optionally, when the collaborative control module executes the power smoothing logic, if it detects that the power generation fluctuation of the wind turbine exceeds the operating condition threshold, it will control the battery module to charge or discharge in order to smooth the total output power at the grid connection point and meet the fluctuation requirements of the power grid.

Optionally, when the collaborative control module executes the low wind speed compensation logic, if it detects that the wind turbine is operating at low wind speed and the power generation is insufficient to meet external demand, it will control the battery module to discharge in order to maintain a stable and continuous power supply.

Optionally, when the collaborative control module executes the capacity redundancy logic, if the available capacity of the battery module decreases due to the low-temperature operating range and the grid connection demand exceeds the battery module's capacity storage capacity, it will automatically activate capacity redundancy to compensate for power output or reception, ensuring that the capacity is not depleted or overflowed.

Optionally, when the collaborative control module executes the cluster collaborative logic, as a member of the wind farm cluster, it will communicate and cooperate with the collaborative control module of other wind turbines in the cluster, so that multiple battery module can work in coordination, jointly respond to regional dispatch instructions, form a virtual power plant, and provide peak shaving, frequency regulation or reserve capacity services.

Optionally, the collaborative control module has a derating operation logic, when it detects that the battery module capacity has decreased due to a fault, or that part of the cooling capacity of the temperature maintaining device has failed, it can automatically reduce the maximum allowable charging and discharging power of the system, sacrificing some performance to ensure the continuous supply of basic power to the wind turbine.

Optionally, the collaborative control module may be further configured to acquire real-time temperature, health status, and maximum available power or capacity data of the battery module, while also incorporating or accessing weather forecast data and load prediction data, and using model predictive control algorithms to pre-plan the charging and discharging behavior of the battery module and the power output curve of the wind turbine, thereby maximizing wind energy utilization, extending battery module lifespan, or improving grid service revenue, and formulating an optimal power storage scheduling plan accordingly.

Optionally, the setting of the low-temperature operating range/operating condition threshold may vary depending on the type, model, chemical system, capacity, rated voltage and operating environment conditions of the battery module.

Optionally, the specific low-temperature operating range/operating condition threshold may be determined through experiments (such as accelerated aging tests, charge-discharge cycle tests, thermal characteristic analysis), empirical data, manufacturer recommendations, or by combining thermal management models, aging models, chemical kinetic simulation predictions, historical operating data statistics, multi-factor combination optimization, and other methods.

Optionally, the upper and lower limits of the low-temperature operating range may be determined according to specific application requirements, including but not limited to selecting from the following listed temperature values as needed (or selecting as needed within a ±2.5° C. range of the following temperature values): −30° C., −25° C., −22.5° C., −20° C., −17.5° C., −15° C., −12.5° C., −10° C., −7.5° C., −5° C., −2.5° C., 0° C., 2.5° C., 5° C., 7.5° C., 10° C., 12.5° C., 15° C., 17.5° C., 20° C., 22.5° C., 25° C., 30° C.

Optionally, the absolute difference between the upper and lower limits of the low-temperature operating range may be determined according to specific application requirements, and is used to limit the width of the life-extending temperature range, including but not limited to selecting from the following values as needed (and also selecting as needed within a ±2.5° C. range of these values): 1° C., 2° C., 3° C., 4° C., 5° C., 10° C., 15° C., 20° C., 25° C., 30° C., 35° C., 40° C.

In addition, the low-temperature operating range may be an upper limit protection (such as the temperature cannot be too high or the current cannot be too high), or a lower limit protection (such as the voltage cannot be too low), or a single-sided constraint (only an upper limit or a lower limit), or a double-sided constraint (both an upper limit and a lower limit).

According to the experimental results, when setting the conditions for ternary lithium batteries, the low-temperature operating range may be set to 5° C.˜15° C., the characteristic variable may be set to the instantaneous charging current, and the operating condition threshold may be set to the 1 C charging rate. When the ternary lithium battery operates in the range of 5° C.˜15° C. and the instantaneous charging current does not exceed the 1 C charging rate, its cycle life (or charge and discharge throughput life) may be significantly extended. The experimental results show that it can reach about 3 times the original life.

According to the experimental results, when setting the conditions for lithium iron phosphate batteries, the low-temperature operating range may be set to 0° C.˜10° C., and the characteristic variables may be set to instantaneous charging current and instantaneous discharging current. The operating condition thresholds may be set to 3 C charging rate and 6 C discharging rate. When the lithium iron phosphate battery operates in the range of 0° C.˜10° C. and the instantaneous charging and discharging rates do not exceed the above thresholds, its cycle life may be significantly extended. Experimental data shows that it can exceed 10 times the cycle life at room temperature. This value is only the test result in the specific embodiment and is used to illustrate the effect. It does not constitute a limitation of this disclosure.

In some embodiments, the overall low-temperature operation control strategy proposed in this invention is to ensure that the battery module operates within the low-temperature range while reducing the charging and discharging current to suppress the side reaction rate and delay the degradation of electrode materials and electrolyte. In particular, the limitation on the charging current is more stringent to prevent the risk of lithium deposition at low-temperatures. Experimental results show that operating within a mild low-temperature range and combined with low-rate charging and discharging does not shorten the battery life. This control strategy is not only applicable to ternary lithium batteries and lithium iron phosphate batteries, but can also be flexibly adjusted according to the characteristics of different battery chemical systems, possessing wide applicability and scalability.

Optionally, the controllable connection element may be used to dynamically adjust, reconstruct, or switch the topological relationship between any functional unit or its sub-components and secondary components in the low-temperature life extension system as needed, so as to support multi-level coupling, flexible switching, on-demand reconstruction, combination and optimization of the temperature control scheme, and enhance the adaptability of the low-temperature life extension system to different operating conditions and functional expansion requirements.

Optionally, the standardized interface enables the rapid installation, disassembly, interchange, and expansion of any functional unit or its sub-components and secondary components in the low-temperature life extension system, simplifies the maintenance, upgrade, and modular transformation process, improves the maintainability, scalability, and reconfigurability of the low-temperature life extension system, and achieves high modularity and convenience of functional upgrades.

Optionally, the collaborative control module can also dynamically optimize the operating sequence, operating mode or operating status, and operating intensity of any functional unit or its sub-components and secondary components in the low-temperature life extension system as needed; The collaborative control module can also dynamically adjust, reconstruct, switch, expand, or optimize the topological connection structure and operating status between any sub-components or secondary components in the low-temperature life extension system as needed; Any functional unit or its sub-components and secondary components in the low-temperature life extension system can also be configured with controllable connection elements and/or standardized interfaces as needed to support the flexible management and system optimization of the collaborative control module.

Optionally, any functional unit or its sub-component or secondary component of the low-temperature life extension system may be arranged independently or in groups at any part of the wind turbine as needed, including but not limited to the inside or outside of the tower, the interior of the nacelle, the foundation platform, the wind turbine blade hub and the nearby ground, and may be coupled, integrated or independently suspended with the original structure of the wind turbine; at the same time, modular interchangeability, zoned collaborative control and multi-point redundant arrangement may be realized to take into account system performance, maintenance safety and thermal management efficiency.

Optionally, the specific implementation of the capacity redundancy function of the battery module includes hard redundancy and soft redundancy; the hard redundancy is achieved by reserving redundant cells in the battery module. The redundant cells are on standby during normal operation. When the collaborative control module detects that the available capacity of the battery module is insufficient, the collaborative control module can enable the redundant cells to work together with the regular cells to compensate for the insufficient capacity; the soft redundancy is achieved by reserving additional capacity during the design of the battery module. The battery module maintains low-load operation during normal operation. When the collaborative control module detects that the available capacity of the battery module is insufficient, the collaborative control module can switch the battery module to a high-load state to operate at full capacity to ensure that the overall capacity meets the requirements.

Optionally, the low-temperature operating range is about 10° C.; the low-temperature operating range can also be about 15° C.; the low-temperature operating range can also be about 20° C.

Optionally, the types of batteries include lithium-ion batteries (such as lithium iron phosphate, ternary system), sodium-ion batteries, nickel-metal hydride batteries, lead-acid batteries, all-solid-state batteries, supercapacitors, and other recyclable electrochemical energy storage devices; the forms of the batteries include single cells, battery cells, battery packs, battery clusters, and other modular units; the structures of the batteries include stacked, layered, honeycomb, flexible, folded, and modular splicing structures to adapt to different capacity, power, and space requirements; the shapes of the batteries include cylindrical cells, square aluminum-cased cells, soft-pack cells, as well as rectangular, sheet-like, annular, rollable flexible sheets, or other geometric forms; the packaging forms of the batteries include metal shells, plastic shells, composite material shells, soft-pack packaging, modular shells, protective seals, heat dissipation enhanced packaging, embedded packaging, or surface coating packaging to achieve environmental protection, thermal management, and mechanical strength.

Optionally, the battery module may be arranged inside the wind turbine tower, while the heat dissipation terminal of the temperature maintaining device may be arranged outside the tower. The battery module and the heat dissipation terminal achieve heat transfer through heat conduction pipes passing through the tower wall.

Optionally, when the wind turbine is an offshore wind turbine, the heat dissipation terminal of the temperature maintaining device may be configured as a seawater heat exchanger coupled to the outer wall of the tower, or a seawater heat exchanger made of corrosion-resistant material and immersed in seawater.

Optionally, when the wind turbine is an onshore wind turbine, the heat dissipation terminal is preferably a ground pipe heat exchanger buried in the foundation soil, or an air cooling tower installed on the ground outside the tower.

Optionally, the heat-conducting pipeline connecting the battery module and the temperature maintaining device adopts a fluid quick-connect/quick-cut interface and a modular valve design to support rapid isolation and disassembly during maintenance.

Optionally, the battery module can also be deployed outside the wind turbine, including the base platform, the nacelle perimeter or the ground auxiliary cabin, and may be flexibly connected and coordinated with the temperature maintaining device, the wind turbine and the collaborative control module through a modular interface.

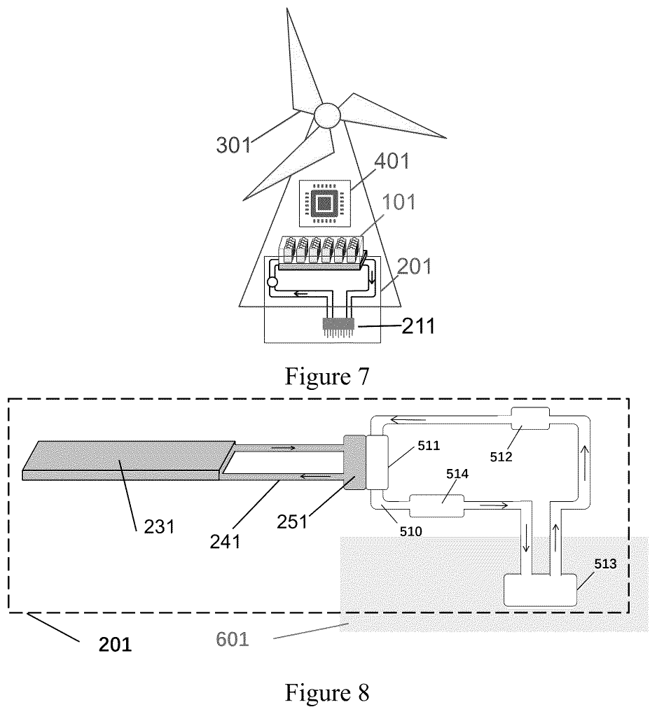

Compared with the embodiment in FIG. 1, the embodiment in FIG. 7 places the heat dissipation terminal outside the wind turbine 301.

Optionally, the sensor network can also collect characteristic variables of the battery module, including state of charge, charge/discharge rate, number of cycles, state of health (SOH), internal impedance, state of charge (SOC), voltage, and current.

Optionally, the sensor network can also collect characteristic variables of the wind turbine, including wind speed, wind direction, blade speed, yaw angle, generator output power, temperature and vibration, as well as voltage, current, frequency and phase of grid interaction, active and reactive power, grid connection/disconnection status and various fault information, so as to fully understand the operation of the wind turbine.

Optionally, the collaborative control module can ensure that the characteristic variables of any functional unit or its sub-components and secondary components in the low-temperature life extension system do not exceed the operating condition threshold during operation.

Optionally, when the collaborative control module detects that the characteristic variables of any functional unit or its sub-components or secondary components in the low-temperature life extension system are close to or exceed the operating condition threshold, the collaborative control module will activate protection measures; the specific forms of the protection measures include, but are not limited to: dynamically adjusting the operating power of the temperature maintaining device to correct the temperature deviation; adjusting the energy interaction rate between the wind turbine and the battery module; reducing, limiting or balancing the charging and discharging power inside the battery module; and cutting off the energy transmission path in extreme cases to avoid irreversible damage to the functional unit due to abnormal operating conditions. The collaborative control module can also predict the system operating trend based on the fusion analysis of external environmental conditions (including but not limited to ambient temperature, wind speed, humidity, etc.) and real-time operating condition data of the functional unit, and issue adjustment commands in advance to achieve preventive protection and optimized operation.

Optionally, the external environmental parameters that the sensor network can collect include ambient temperature, humidity, wind speed, air pressure and light intensity.

Optionally, the form of the temperature equalization device includes, but is not limited to, microchannel liquid cooling plate, liquid cooling temperature equalization plate, serpentine tube liquid cooling, immersion liquid cooling structure, air-cooled heat dissipation duct, forced convection air cooling, hot air circulation channel, heat pipe, flat plate heat pipe, steam chamber, graphite sheet thermal conductive layer, graphene film, carbon nanotube thermal conductive film, metal foam thermal conductive structure, thermal conductive gel, thermal conductive silicone grease, thermal conductive pad, spray cooling, boiling heat exchange and aerogel insulation-thermal conductive composite structure.

Optionally, the phase change material may be arranged in a hierarchical array or deployed in different locations in a hierarchical manner to achieve a hierarchical phase change process through a combination of multiple melting points, storing and releasing cold energy at different temperature points or different locations, thereby enhancing the ability to maintain and regulate low-temperature; the phase change material is composed of microcapsules or polymer composite materials encapsulating the phase change material, specifically deployed in the form of encapsulation, filling or forming a plate.

Optionally, the melting point of the phase change material may be precisely set according to actual needs, and adjusted as needed within the low-temperature operating range, including but not limited to precise control of the melting point through alloy formulation optimization or microcapsule encapsulation technology and other methods.

Optionally, the specific melting point value of the phase change material includes, but is not limited to, the temperature values selected as needed from the following list (or selected as needed within a ±2.5° C. range of the following temperature values): 25° C., 22.5° C., 20° C., 17.5° C., 15° C., 12.5° C., 10° C., 7.5° C., 5° C., 2.5° C., 0° C., −2.5° C., −5° C., −7.5° C., −10° C., −12.5° C., −15° C., −17.5° C., −20° C., −22.5° C., −25° C.

Optionally, the multi-way valve is used to change the path of the fluid to achieve flexible switching of the flow path.

Optionally, the flow regulating valve is used to precisely control the flow rate and flow of the fluid to achieve stepless adjustment of the cooling intensity.

Optionally, the fluid quick-connect/quick-cut interface is used for quick connection and disconnection of the fluid circuit, or to realize quick switching of the flow path in an instant, thereby ensuring rapid response and switching of the cooling mode.

Optionally, the bypass loop is used to provide a backup or diversion path to enhance the redundancy and reliability of the system.

Optionally, the electrical quick-connect plug is used to realize hot-swapping of electrical connection; the modular heat-conducting interface is used to realize thermal contact and efficient heat exchange between different modules; the modular mounting component is used to realize mechanical fixation and quick disassembly.

Optionally, the collaborative control module can also collect ambient temperature and humidity data in real time through the sensor network, and accurately calculate the current dew point temperature based on the collected data. At the same time, it can dynamically adjust the temperature control target of the battery module in combination with the battery module operating status, heat dissipation conditions, safety margin, external environmental changes and other factors, so that the surface temperature of the battery module is always maintained above the dew point temperature. This can effectively avoid the risk of condensation on the surface of the battery module or the inner wall of the cabin in more complex and changeable environments, and improve the overall environmental adaptability and reliability of the system.

Optionally, the anti-vibration structure may be selected from one or more of the following combinations: elastic damping bearing, buffer pad, damping component, suspension support structure, vibration isolation cavity, flexible connector, gradient stiffness support, viscoelastic damping material, friction damping unit, fluid damper, pneumatic adjustment cavity, magnetic levitation vibration isolator, shape memory alloy support, electronically controlled intelligent damper, liquid-gas hybrid vibration isolation system and multi-layer suspension platform.

Optionally, the elastic damping support is usually arranged at the bottom and side wall to provide basic vibration isolation; the buffer pad layer adopts a gradient stiffness material, which can absorb impacts of different amplitudes step by step; the damping component consumes vibration energy through viscoelastic materials, friction pairs or fluid cavities; the suspended support structure and vibration isolation cavity are suitable for attenuation of medium and low frequency vibrations; the flexible connector and gradient stiffness support take into account both tower interface and large load transmission; the magnetic levitation vibration isolator, electronically controlled intelligent damper and shape memory alloy support have adaptive adjustment function, which can change the damping and stiffness in real time according to the wind turbine operating status or ambient temperature; the liquid-gas hybrid vibration isolation system and multi-layer suspension platform are suitable for extreme wind speed or strong impact conditions.

Optionally, the ballast system includes a ballast water tank and a buoyancy chamber.

Optionally, the ballast water tank can achieve ballast adjustment by filling and draining water. Its sub-components may include water pumps, pipelines, valves and liquid level sensors for controlling the inflow and outflow of water and accurately monitoring the water volume.

Optionally, the buoyancy chamber can change buoyancy by filling and discharging gas, and its sub-components may include a compressor, a gas storage tank, an inlet and outlet valve and a pressure sensor for controlling the inlet and outlet of gas and maintaining pressure in the chamber.

Optionally, the ballast system can interact with the collaborative control module to dynamically adjust the ballast tank and buoyancy chamber based on the attitude information, external environmental parameters and operating conditions collected by the sensor network, so as to improve the system's anti-disturbance capability and operational safety.

Optionally, when applied to offshore wind turbines, the ballast tank may be reused as part of a secondary circuit to introduce seawater as a cooling medium; after flowing through the ballast tank, the seawater is pumped into a secondary heat exchanger coupled to the liquid cooling circuit, and after completing the heat exchange, it is discharged back to the ocean, or directly exchanges heat with the system inside the ballast tank.

Optionally, when the low-temperature life extension system is applied to an offshore wind turbine, the temperature maintaining device can directly use the ballast water tank for heat dissipation; after the seawater flows through the ballast water tank, it is pumped into a heat exchanger coupled to the liquid cooling circuit, and after completing the heat exchange, it is discharged back to the ocean, or it can directly exchange heat with the system inside the ballast water tank.

Optionally, the heating object of the thermal compensation unit may be flexibly configured according to actual thermal management needs, including but not limited to battery module, liquid cooling circuits, energy storage compartments or liquid cooling plates that are in thermal contact with battery module, so as to provide effective heating effects in low-temperature environments, rapid heating, emergency heat preservation and other scenarios.

Optionally, the cooling object of the refrigeration system may be flexibly configured according to actual thermal management needs, including but not limited to battery module, liquid cooling circuits, energy storage compartments or liquid cooling plates that are in thermal contact with battery module, thereby providing enhanced cooling capabilities in high-temperature environments, high-rate operation, emergency heat dissipation needs and other scenarios.

Optionally, the fluid controllable connection element includes a multi-way valve, a flow regulating valve, an electric switching valve, a proportional valve, a micro pump or a controllable pump unit, a fluid quick-connect/quick-switch interface, a bypass circuit, a one-way valve or a check valve; the thermal energy controllable connection element includes a thermal switch or thermal control valve, an adjustable heat pipe, a hot fluid bypass, and a micro cooling unit; the electrical energy controllable connection element includes a programmable relay, a solid-state switch, an electromagnetic switcher, and a controllable power distribution unit; the information controllable connection element includes an optical fiber splitter, an optical fiber multiplexer, a signal switching matrix, a bus arbitration unit, a controllable router or a switching switch; the mechanical controllable connection element includes a mechanical switching coupling, a clutch, and a torque distributor.

Optionally, the electrical interface includes an electrical quick-connect plug, a board-to-board connector, a spring pin interface, a flexible flat cable quick-connect interface, a high-frequency radio frequency interface, a magnetic power or signal interface, and a hot-swapping battery interface; the fluid interface includes a fluid quick-connect or quick-cut interface, a modular liquid cooling interface, a modular air cooling interface, and a standardized pipeline connector; the thermal interface includes a modular heat-conducting interface, a hot-swapping heat dissipation module interface, and a phase change material heat-conducting coupling component; the information interface includes an optical fiber interface, a standardized bus interface (including CAN, Ethernet, USB, RS485, etc.), and a wireless near-field communication interface (including NFC, Bluetooth, UWB, etc.); the mechanical interface includes a modular mounting component, a rail snap-fit fixing interface, a threaded/snap-fit combination quick-fixing interface, and a magnetic mechanical docking component.

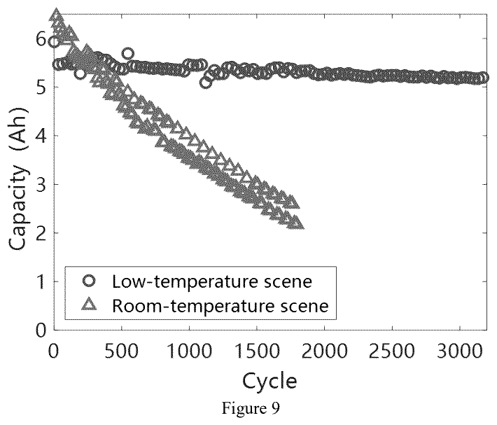

FIG. 9 shows the original experimental data to illustrate the low-temperature life extension effect of this case. The “Δ” symbol in the figure represents the battery degradation data in the normal temperature (25° C.) scenario. It may be observed that its initial capacity is relatively high (about 6.5 Ah), but it decays to about 2.5 Ah after about 1700 cycles. The “∘” symbol in the figure represents the battery degradation data in the low-temperature (15° C.) scenario. It may be seen that although its initial capacity is relatively low (about 5.5 Ah), it still basically maintains about 5.2 Ah after 3000 cycles, and the degree of decay is negligible. It may be seen that although low-temperature will lead to a decrease in the initial capacity of the battery, in the long run, its life benefit is significantly greater. On the other hand, the normal temperature scenario only has a capacity advantage in the early stage of degradation, and its life is significantly worse than that of the low-temperature scenario. In the current new energy storage scenario, the multiple extension of battery life is the key factor that determines its long-term operating economy.

The application of the low-temperature life extension system of the present invention in wind turbine units also has other implementation methods. First, an integrated energy storage life extension system for offshore wind turbine units: the battery module is integrated with the wind turbine tower or foundation platform, the temperature maintaining device adopts a combination of seawater heat exchanger and liquid cooling circuit for heat dissipation, and the collaborative control module is interconnected with the wind farm cluster control system to achieve grid-connected power smoothing and frequency regulation, which is suitable for large-scale offshore wind power bases. Second, an underground energy storage compartment for onshore wind farms: the battery module is arranged in the energy storage compartment under the tower base, using soil heat exchanger for passive heat dissipation and combined with phase change material to regulate temperature, and the collaborative control module combines weather forecast and load prediction to execute model predictive control, which is suitable for desert or plateau wind farms with large diurnal temperature differences. Third, an integrated battery and temperature control unit for wind turbine nacelles: the battery module and temperature maintaining device are tightly integrated into the nacelle, and forced ventilation and thermal compensation devices are used for regulation. At the same time, the battery module can also serve as nacelle counterweight, saving structural costs, which is especially suitable for small and medium-sized wind turbines. Fourth, the virtual power plant collaborative operation mode: Multiple wind turbines' collaborative control module are interconnected, and multiple battery module constitute a regional virtual power plant, achieving peak shaving, frequency regulation, and reserve capacity services to meet the flexibility needs of the future electricity market. Fifth, extreme climate-adaptive energy storage system: In cold regions, the battery module operating temperature is maintained between −20° C. and 0° C. A combination of heat pumps, phase change materials, and redundant cells significantly extends battery life and reduces maintenance frequency. Sixth, vibration-resistant tower battery module: Battery module are arranged inside the tower, using multi-layered suspended platforms and viscoelastic damping materials to resist vibration. The collaborative control module dynamically adjusts charging and discharging strategies to reduce the impact of wind turbine vibration on the batteries, suitable for wind farms in strong wind areas or earthquake zones. Seventh, integrated energy storage solution for offshore floating wind turbines: Battery module are coupled with ballast tanks to achieve integrated counterweight and liquid cooling. The collaborative control module manages battery capacity redundancy and power smoothing, making it particularly suitable for floating offshore wind farms. Eighth, Distributed Energy Storage and Wake Optimization Synergy: Each wind turbine is equipped with an independent battery module, which provides supplemental power at low wind speeds and reduces peak loads at high wind speeds. Combined with wake effect optimization, this improves the overall energy utilization and economy of the wind farm. Ninth, Intelligent Anti-Condensation and Fire Safety Energy Storage Compartment: The collaborative control module calculates the dew point temperature in real time and adjusts the temperature maintaining device to prevent condensation. The energy storage compartment also integrates an inert gas fire extinguishing system, automatic pressure relief valve, and insulated walls, significantly improving intrinsic safety, especially suitable for high-humidity offshore or coastal wind farms. Tenth, Unmanned Wind Farm Operation and Maintenance Optimization Solution: The battery module have hot-swapping interfaces and automatic identification functions, enabling rapid replacement and parameter synchronization. It also supports drone or robot-assisted maintenance. Simultaneously, the collaborative control module is interconnected with the cloud to achieve remote diagnosis and operation and maintenance strategy updates, suitable for future intelligent, low-manpower wind farms.

It should be understood that the specification and drawings of this invention are only used to illustrate the technical solutions of this invention by way of example, and are not intended to limit its scope of protection. The scope of protection of this invention shall be determined by the claims. Any content not expressly stated in the specification but which may be defined by the claims shall be deemed to fall within the scope of protection of this invention.

Those skilled in the art can make various modifications, substitutions, adjustments and improvements to the technical solutions described in this invention without departing from the concept of this invention. Such equivalent solutions or variations should be included within the protection scope of this invention. For example, the division of functional units, the structural form of components, the connection method of the system, the execution order of the process, etc., may be reasonably changed according to specific needs, and such changes should not be regarded as a substantial limitation on the protection scope of this invention.

The embodiments described in the specification only illustrate one or several possible implementations. Those skilled in the art should understand that many other different specific implementations are possible without departing from the basic ideas and core technical concepts of the present invention. All equivalent solutions made in accordance with the basic principles of the present invention should be covered within the protection scope of the present invention.

The technical features disclosed in different embodiments may be combined, matched, or substituted in any form, provided there is no structural or functional conflict. These combinations include not only the combinations explicitly described in the specification, but also reasonable combinations that a person skilled in the art can naturally conceive of after reading the specification. All such combinations should be considered to fall within the protection scope of this invention.

Furthermore, the parameters, numerical ranges, processing conditions, and material selections mentioned in the specification are merely illustrative descriptions and do not constitute a limitation on the scope of protection of this invention. Those skilled in the art can make appropriate adjustments, modifications, or optimizations to the above content according to the needs of actual applications, and such modifications or optimizations based on the ideas of this invention should also be protected by this invention.

The accompanying drawings referenced in this specification are mainly for illustrative purposes and are not intended to limit the scope of protection of this invention. The scales, layouts, dimensions, and orientations shown in the drawings are for illustrative purposes only and do not limit the specific implementation of this invention. The scope of protection of this invention should not be affected by the specific presentation of the drawings.

The technical solution of the present invention is not limited to the scenarios disclosed in the specification, but can also be flexibly extended to other similar or related technical fields. Those skilled in the art can apply it to different systems, devices or methods based on the basic concept of the present invention, as long as it does not deviate from the core technical idea of the present invention, it shall fall within the protection scope of the present invention.

It should be further emphasized that the specification and drawings of this invention are for the purpose of helping to understand the principles and concepts of the invention, and are not intended to limit the scope of the claims. Any equivalent substitutions, obvious modifications or functional extensions made based on the technical concept of this invention should be considered to fall within the scope of protection of this invention.

In summary, the present invention aims to solve the technical problems in related technical fields and achieve the expected functional goals and technical effects. The scope of protection of the present invention shall be determined by the claims, and any modifications, substitutions, combinations, extensions and optimizations within this scope shall be protected by law.

1. A low-temperature life extension system for wind turbine coupled with energy storage, characterized in that,
The low-temperature life extension system includes several functional units, sub-components and secondary components; The functional units may include, but are not limited to, battery module, temperature maintaining device, wind turbine and collaborative control module;
The battery module is used to store electrical energy generated by the wind turbine;
The temperature maintaining device can regulate the temperature of the battery module and maintain it within the low-temperature operating range to achieve the purpose of extending battery life at low-temperatures;
The wind turbine is used to convert wind energy into electrical energy and interact with the battery module;
The collaborative control module can acquire the operating status and external environment information of each functional unit in the low-temperature life extension system, and perform collaborative optimization control of each functional unit in the low-temperature life extension system in conjunction with the decision control algorithm;
The low-temperature operating range is a range of temperatures above the dew point but below room temperature; When the battery module is used for a long time within the low-temperature operating range, the aging or degradation of electrode materials and electrolytes will be effectively delayed, significantly extending the life of the battery module, thereby improve the economic efficiency of the entire life cycle;
Any functional unit or its sub-components and secondary components of the low-temperature life extension system may be selected with anti-vibration structures as needed to suppress vibrations and shocks generated during operation;
The temperature maintaining device is designed to actively promote a decrease in temperature (to extend service life), rather than being used solely to prevent thermal runaway in the traditional sense;
The functional unit refers to the overall module used to realize the main function in the low-temperature life extension system; The sub-component refers to the subdivided structure or independently operable component under the functional unit; The secondary component refers to the specific element or hardware component after further subdivision of the sub-component.

2. The low-temperature life extension system according to the preceding claim, characterized in that,
The temperature maintaining device may use any of the following temperature control methods: passive heat dissipation, air cooling, convection cooling, active cooling and thermal compensation; Alternatively, two or more of these methods may be combined to construct a multi-level coupling temperature control scheme to meet the needs of different environmental conditions and heat loads; At the same time, the temperature maintaining device may be configured with corresponding sub-components according to actual needs to achieve the required temperature control method;
When the battery module operates in the low-temperature operating range, although the battery module's lifespan may be extended, its initial capacity will be reduced due to the decrease in the electrochemical reaction rate; therefore, the battery module can also be configured with a capacity redundancy function;
The capacity redundancy function compensates for the negative impact of low-temperature environment on the capacity of the battery module by reserving additional capacity in advance; the capacity redundancy function is an optional configuration;
The temperature maintaining device can adopt a passive heat dissipation strategy as needed to reduce heat dissipation energy consumption;
The collaborative control module also integrates the functions of a battery management system, including but not limited to monitoring and managing the operating status of the battery module, balancing the voltage and capacity of each individual cell in the battery module, and interacting with any sub-component or secondary component in the temperature maintaining device to achieve collaborative and optimized energy management;
When applied in offshore wind power scenarios, the battery module can also serve as a counterweight, partially or completely replacing the original counterweight components of the wind turbine, thereby achieving structural reuse and cost savings;
The sub-components of the collaborative control module include a sensor network, which monitors on demand the characteristic variables of any functional unit or its sub-components, and secondary components of the low-temperature life extension system, along with external environmental parameters;
The collaborative control module can ensure that one or more characteristic variables of the battery module do not exceed the operating condition threshold during charging and discharging, thereby avoiding damage to the battery module due to excessively high side reaction rates under adverse conditions; the characteristic variables include charging current.

3. The low-temperature life extension system according to claim 2, characterized in that,
The functional units, sub-components and secondary components of the low-temperature life extension system may be selected and configured as needed; wherein the electrical parts adopt a sealed structure to suppress condensation and enhance the system's adaptability to low-temperature environments;
The setting of the low-temperature operating range/ operating condition threshold may vary depending on the type, model, chemical system, capacity, rated voltage and operating environment conditions of the battery module;
Any functional unit or any sub-component or secondary component of the low-temperature life extension system has high flexibility in spatial arrangement and may be optimized and deployed according to wind farm environmental conditions, temperature control requirements, maintenance convenience, wind turbine structural constraints, airflow channels, local temperature control optimization, heat load balance, vibration isolation requirements, electrical circuit layout, load bearing capacity, maintenance strategy, and ease of installation and replacement;
When the collaborative control module detects that one or more characteristic variables are close to or exceed the operating condition threshold, the collaborative control module will activate protection measures; the forms of protection measures include reducing charging current, reducing discharging current, limiting power or voltage, cutting off the charging and discharging circuit, and issuing an alarm signal;
The capacity redundancy function is achieved by adding an auxiliary battery pack to the battery module and operating it in coordination, or by designing the total capacity of the battery module according to a preset redundancy ratio, so that the actual total capacity exceeds the requirements of the application scenario;
The capacity redundancy function can not only compensate for the capacity loss of the battery module in the low-temperature life extension range, but also further improve the life of the battery module on the basis of the life extension caused by low-temperature;
The battery module may not serve as a counterweight and may not be used as a counterweight component of the wind turbine. Instead, it may be arranged as a pure battery module in the empty space inside the tower or on the tower base platform to adapt to different wind turbine structures and installation requirements;
The size, mass, center of gravity distribution, and deployment position of the battery module may be optimized and customized according to the rated power, rotor length, tower height and structural characteristics of the wind turbine to meet the overall center of gravity and stability requirements of the wind turbine;
The sub-components of the battery module include a battery, an energy storage compartment and a modular interface; the energy storage compartment is a shell structure used for the battery module and provides sealing and protection; the modular interface is used to enable the expansion, replacement or maintenance of the battery module.

4. The low-temperature life extension system according to claim 3, characterized in that,
The battery module may be arranged in any of the following ways: inside the wind turbine tower; inside the wind turbine nacelle; in an independent energy storage compartment adjacent to the wind turbine; or near the centralized control station or collection line node of the wind farm;
The specific low-temperature operating range/ operating condition threshold may be determined through experiments (such as accelerated aging tests, charge-discharge cycle tests, thermal characteristic analysis), empirical data, manufacturer recommendations, or by combining thermal management models, aging models, chemical kinetic simulation predictions, historical operating data statistics, multi-factor combination optimization, and other methods;
The energy storage compartment can achieve passive heat dissipation by being in close contact with the structure of the wind turbine and utilizing its thermal conductivity and heat dissipation characteristics;
The sub-component of the temperature maintaining device may further include a liquid cooling circuit to achieve convective heat dissipation;
The liquid cooling circuit can adopt any of the following methods: plate liquid cooling, tube liquid cooling, microchannel liquid cooling, immersion liquid cooling, sandwich liquid cooling or shell integrated liquid cooling, or a combination of multiple methods to achieve heat exchange of the battery module;
The secondary components of the liquid cooling circuit may include liquid cooling plates, cooling pipes, serpentine pipes, coils, microchannel cooling plates, jacketed cooling fins, liquid cooling shells, liquid pumps, heat exchangers, heat dissipation terminals, control valves, sensors, and coolant storage tanks, and may be freely selected and flexibly combined according to different liquid cooling requirements and design schemes;
The battery module can directly contact the temperature maintaining device or any of its sub-components or secondary components as needed to achieve efficient thermal coupling;
The battery module may be physically integrated with the temperature maintaining device or any of its sub-components or secondary components as needed to form a unified and indivisible functional unit;
The battery module and the temperature maintaining device or any of its sub-components or secondary components can also be arranged relatively independently and separately, and efficient thermal coupling may be achieved through flexible heat conduction pipes, liquid cooling circuits or thermal conduction interfaces, so that they may be flexibly deployed according to the wind turbine structure, environmental conditions and maintenance strategies.

5. The low-temperature life extension system according to claim 4, characterized in that,
The battery module or the temperature maintaining device may be installed as needed in the tower of the wind turbine, the surrounding structure of the tower, the interior of the nacelle, the foundation platform, the ground auxiliary cabin, the underground structure, and other suitable auxiliary structures;
In the offshore wind power scenarios, the sub-component of the wind turbine may also include a ballast system as needed, which is used to adjust the overall center of gravity and buoyancy distribution of the wind turbine to enhance the stability of the system during operation;
The sub-component of the temperature maintaining device may also include a forced ventilation duct and a fan to achieve the purpose of air cooling;
The sub-component of the temperature maintaining device may further include a secondary circuit for direct heat dissipation from the external natural cold source, but isolating the external natural cold source from corrosion or other negative effects;
The sub-component of the temperature maintaining device may further include a refrigeration system to achieve active cooling;
The sub-component of the temperature maintaining device may further include a thermal compensation unit for achieving thermal compensation;
Any functional unit or its sub-components and secondary components in the low-temperature life extension system may be equipped with a temperature equalization device as needed to improve the overall temperature uniformity and thermal response efficiency of each sub-component;
Any functional unit or its sub-components and secondary components in the low-temperature life extension system may be equipped with phase change materials as needed to absorb or release heat when the heat load changes abruptly, so as to realize peak shaving and valley filling of thermal management and realize cross-day and cross-seasonal temperature control optimization;
The collaborative control module can accurately monitor environmental information and flexibly adjust the multi-level coupling temperature control scheme (including but not limited to adjusting the coupling method or temperature control intensity) to keep the temperature of the battery module always within the low-temperature operating range, but above the dew point to avoid the risk of condensation.

6. The low-temperature life extension system according to claim 5, characterized in that,
The characteristic variables may also include one or more of the following: charging voltage, discharging voltage, discharging current, charging and discharging power, temperature, and other battery operating parameters;
The collaborative control module can also be equipped with a decision control algorithm to realize real-time analysis and calculation of the information collected by the sensor network, and then dynamically optimize the operation sequence or operation mode, operation status and operation intensity of any sub-component or secondary component in the temperature maintaining device as needed, so as to ensure that the temperature of the battery module may be maintained within the low-temperature operating range;
Any sub-component or secondary component in the temperature maintaining device may be arranged in zones according to the area division of the battery module and work together to achieve synchronous heat dissipation, local temperature control and priority heat dissipation of high-heat areas in each area of the battery module, thereby improving the overall thermal management efficiency;
Any sub-component or secondary component in the temperature maintaining device can also be integrated with the battery module as needed to achieve a tight combination of heat dissipation structure, forming centralized heat dissipation and overall temperature control, thereby improving the compactness and heat dissipation efficiency of the device;
Any sub-component or secondary component in the temperature maintaining device may be repeatedly configured as needed to achieve fault redundancy; When some sub-components or secondary components fail, they may be isolated from the fault and then taken over by other sub-components or secondary components to ensure the stability of the overall system;
Any sub-component or secondary component in the temperature maintaining device may be repeated in parallel as needed to enhance functionality, and may be controlled hierarchically through graded start-stop and graded adjustment, thereby taking into account both energy efficiency and precise control;
The temperature maintaining device adopts a modular design concept, wherein any sub-component or secondary component may be used as a modular installation unit as needed, and may be quickly assembled, disassembled, maintained, expanded and upgraded through quick connectors.

7. The low-temperature life extension system according to claim 6, characterized in that,
Specific methods for achieving passive heat dissipation include, but are not limited to, directly conducting heat between the energy storage compartment and the inner wall of the wind turbine tower, concrete foundation or building wall, thereby transferring heat to the structure with a large heat capacity or surface area, and finally dissipating it to the surrounding environment through air convection and radiation on the outer surface of the structure;
The forced ventilation duct and fan can promote airflow to the location where heat dissipation is required, enhance the air convection heat transfer effect, and thus provide targeted heat dissipation for any sub-component or secondary component of the battery module or temperature maintaining device;
The heat dissipation terminal may be flexibly set in the system interior, external environment or underground foundation according to the system deployment environment and cold source conditions, and cool the coolant in the circuit through direct contact or indirect coupling. The direct contact method allows the heat dissipation terminal to be immersed or exposed to seawater, surface water, soil or flowing air and other natural cold sources to achieve direct heat exchange. The indirect coupling method uses an intermediate heat exchanger to perform isolated heat exchange with the above-mentioned natural cold sources to adapt to the heat dissipation requirements of different corrosiveness, cleanliness and temperature conditions;
The secondary circuit introduces seawater, lake water or groundwater as a cooling medium through corrosion-resistant pipelines, and then exchanges heat with the liquid cooling circuit, energy storage compartment or battery module through a secondary heat exchanger; The cooling medium after heat exchange may be discharged back to nature or recycled;
The refrigeration system can perform targeted cooling and temperature reduction on any sub-component or secondary component in the temperature maintaining device as needed;
The refrigeration system can employ any of the following principles: compressor refrigeration, thermoelectric refrigeration (semiconductor refrigeration), absorption refrigeration, or other refrigeration principles; The refrigeration system can also use a combination of the above-mentioned principles to achieve active refrigeration;
The secondary components of the refrigeration system may include a compressor, condenser, throttling device, evaporator, thermoelectric cooling chip, heat sink, DC power module, temperature control drive circuit, generator, absorber, heat exchanger, liquid cooling plate, cooling pump, refrigeration pipeline, control valve and sensor, and may be selected and matched as needed according to different refrigeration principles;
The thermal compensation unit may adopt any one of the following thermal compensation principles: positive temperature coefficient (PTC) electric heater, electric heating film, liquid thermal circuit heating device or heat pump device; or thermal compensation may be achieved through a combination of multiple thermal compensation principles;
The secondary components of the thermal compensation unit may include heating elements, heat exchange plates or heat exchange pipelines, circulating pumps, heat transfer medium pipelines, heat dissipation and insulation structures, power supply modules, temperature sensors, controllers, actuators, connectors and safety protection components, and may be selected and matched as needed according to different thermal compensation principles;
The thermal compensation unit can perform directional thermal compensation on any sub-component or secondary component in the temperature maintaining device as needed.

8. The low-temperature life extension system according to claim 7, characterized in that,
The collaborative control module can also dynamically adjust, reconstruct, switch, expand, and optimize the topological connection structure and operating status between any sub-component or secondary component in the temperature maintaining device as needed, so as to flexibly adapt to the temperature control requirements under different working conditions;
The temperature maintaining device may be configured with controllable connection elements and/or standardized interfaces as needed to support flexible management and system optimization of the collaborative control module;
The controllable connection element is used to realize the dynamic adjustment of the topology; The types of controllable connection element include fluid controllable connection elements, thermal controllable connection elements, electrical controllable connection elements, information controllable connection elements, and mechanical controllable connection elements, including but not limited to multi-way valves, flow regulating valves, fluid quick-connect/quick-cut interfaces, and bypass circuits;
The standardized interface is used to realize the quick connection and/or hot-swapping of the physical structures; The types of standardized interface include electrical interfaces, fluid interfaces, thermal interfaces, information interfaces and mechanical interfaces, including but not limited to electrical quick-connect plugs, fluid quick-connect/quick-switching interfaces, modular heat-conducting interfaces and modular mounting components;
The energy storage compartment adopts a modular sealed shell structure, and an anti-corrosion coating is applied to the outer surface of the energy storage compartment to resist long-term erosion from marine salt spray and high humidity environment, and to ensure the structural integrity and reliability of the energy storage compartment;
The energy storage compartment is equipped with a fire suppression and explosion suppression device, including but not limited to an inert gas fire extinguishing agent spray system or a perfluorohexanone fire extinguishing system;
The energy storage compartment is equipped with an automatic pressure relief valve and a guide pressure relief channel, which are used to quickly release high-pressure gas and ejected material when the battery experiences thermal runaway and guide them to a safe area;
The important areas inside the energy storage compartment are separated by heat-insulated walls to prevent the heat generated by the battery module after thermal runaway from spreading to other areas;
The battery module is arranged in a modular combination manner, which can support capacity expansion and technology upgrade, while improving maintainability and operational reliability;
The battery module is divided into multiple electrically isolated battery sub-modules, and each battery sub-module is equipped with a disconnect switch or DC circuit breaker; When a battery sub-module fails, it may be quickly isolated to prevent the fault from spreading and ensure that the entire battery module continues to operate;
The battery module has a standardized interface for quick installation and removal or hot-swapping, and is equipped with automatic identification and parameter synchronization functions, enabling the battery module to be maintained, replaced or expanded without affecting the overall operation of the energy storage compartment; It also supports unattended or semi-automated operation and maintenance, thereby further improving the flexibility and reliability of the system.

9. The low-temperature life extension system according to claim 8, characterized in that,
The collaborative control module is connected to the main controller of the wind turbine and the power grid dispatch center to coordinate the power generation of the wind turbine and the charging and discharging process of the battery module, so as to achieve smooth output of power at the grid connection point and support the off-grid operation mode;
The collaborative control module is configured to execute one or more of the following working logics: power smoothing logic, low wind speed compensation logic, capacity redundancy logic, and cluster collaborative logic;
When the collaborative control module executes the power smoothing logic, if it detects that the power generation fluctuation of the wind turbine exceeds the operating condition threshold, it will control the battery module to charge or discharge in order to smooth the total output power at the grid connection point and meet the fluctuation requirements of the power grid;
When the collaborative control module executes the low wind speed compensation logic, if it detects that the wind turbine is operating at low wind speed and the power generation is insufficient to meet external demand, it will control the battery module to discharge in order to maintain a stable and continuous power supply;
When the collaborative control module executes the capacity redundancy logic, if the available capacity of the battery module decreases due to the low-temperature operating range and the grid connection demand exceeds the battery module's capacity storage capacity, it will automatically activate capacity redundancy to compensate for power output or reception, ensuring that the capacity is not depleted or overflowed;
When the collaborative control module executes the cluster collaborative logic, as a member of the wind farm cluster, it will communicate and cooperate with the collaborative control module of other wind turbines in the cluster, so that multiple battery module can work in coordination, jointly respond to regional dispatch instructions, form a virtual power plant, and provide peak shaving, frequency regulation or reserve capacity services;
The collaborative control module has a derating operation logic, when it detects that the battery module capacity has decreased due to a fault, or that part of the cooling capacity of the temperature maintaining device has failed, it can automatically reduce the maximum allowable charging and discharging power of the system, sacrificing some performance to ensure the continuous supply of basic power to the wind turbine;
The upper and lower limits of the low-temperature operating range may be determined according to specific application requirements, including but not limited to selecting from the following listed temperature values as needed (or selecting as needed within a ±2.5° C. range of the following temperature values): −30° C., −25° C., −22.5° C., −20° C., −17.5° C., −15° C.,−12.5° C., −10° C., −7.5° C., −5° C., −2.5° C., 0° C., 2.5° C., 5° C., 7.5° C., 10° C., 12.5° C., 15° C., 17.5° C., 20° C., 22.5° C., 25° C., 30° C.;
The absolute difference between the upper and lower limits of the low-temperature operating range may be determined according to specific application requirements, and is used to limit the width of the life-extending temperature range, including but not limited to selecting from the following values as needed (and also selecting as needed within a ±2.5° C. range of these values): 1° C., 2° C., 3° C., 4° C., 5° C., 10° C., 15° C., 20° C., 25° C., 30° C., 35° C., 40° C.

10. The low-temperature life extension system according to claim 9, characterized in that,
The collaborative control module may be further configured to acquire real-time temperature, health status, and maximum available power or capacity data of the battery module, while also incorporating or accessing weather forecast data and load prediction data, and using model predictive control algorithms to pre-plan the charging and discharging behavior of the battery module and the power output curve of the wind turbine, thereby maximizing wind energy utilization, extending battery module lifespan, or improving grid service revenue, and formulating an optimal power storage scheduling plan accordingly;
The low-temperature operating range is about 10° C.; the low-temperature operating range can also be about 15° C.; the low-temperature operating range can also be about 20° C.;
The controllable connection element may be used to dynamically adjust, reconstruct, or switch the topological relationship between any functional unit or its sub-components and secondary components in the low-temperature life extension system as needed, so as to support multi-level coupling, flexible switching, on-demand reconstruction, combination and optimization of the temperature control scheme, and enhance the adaptability of the low-temperature life extension system to different operating conditions and functional expansion requirements;
The standardized interface enables the rapid installation, disassembly, interchange, and expansion of any functional unit or its sub-components and secondary components in the low-temperature life extension system, simplifies the maintenance, upgrade, and modular transformation process, improves the maintainability, scalability, and reconfigurability of the low-temperature life extension system, and achieves high modularity and convenience of functional upgrades;
The collaborative control module can also dynamically optimize the operating sequence, operating mode or operating status, and operating intensity of any functional unit or its sub-components and secondary components in the low-temperature life extension system as needed; The collaborative control module can also dynamically adjust, reconstruct, switch, expand, or optimize the topological connection structure and operating status between any sub-components or secondary components in the low-temperature life extension system as needed; Any functional unit or its sub-components and secondary components in the low-temperature life extension system can also be configured with controllable connection elements and /or standardized interfaces as needed to support the flexible management and system optimization of the collaborative control module;
Any functional unit or its sub-component or secondary component of the low-temperature life extension system may be arranged independently or in groups at any part of the wind turbine as needed, including but not limited to the inside or outside of the tower, the interior of the nacelle, the foundation platform, the wind turbine blade hub and the nearby ground, and may be coupled, integrated or independently suspended with the original structure of the wind turbine; at the same time, modular interchangeability, zoned collaborative control and multi-point redundant arrangement may be realized to take into account system performance, maintenance safety and thermal management efficiency.
